(19) United States
(12) Patent Application Publication
(10) Pub. No.: US 2026/0355633 A1
(43) Pub. Date: Nov. 12, 2026

(54) METHOD AND APPARATUS FOR OBTAINING PIECE IN TURN-BASED BOARD GAME, DEVICE, AND STORAGE MEDIUM

(71) Applicant: Tencent Technology (Shenzhen) Company Limited, Shenzhen (CN)

(72) Inventor: Ziqi WEI, Shenzhen (CN)

(21) Appl. No.: 19/718,595

(22) Filed: Jun. 24, 2026

Related U.S. Application Data
(63) Continuation of application No. PCT/CN2025/082939, filed on Mar. 17, 2025.

(30) Foreign Application Priority Data
May 9, 2024 (CN) 202410573108.3

(51) Int. Cl. A63F 13/58; A63F 13/533; A63F 13/69; A63F 13/822

(52) U.S. Cl. CPC A63F 13/58; A63F 13/533; A63F 13/69; A63F 13/822

(57) ABSTRACT

A method for obtaining a piece in a turn-based board game is performed by a computer device. The method includes: transmitting a piece obtaining request to a server in an i^{th} turn of a turn-based board game; displaying piece information of at least one standby piece when a target resource value returned by the server based on the piece obtaining request is received, the target resource value being a resource value determined from resource values unlockable at a game level of a game object based on battle information of the game object in an (i−1)^{th} turn, and the resource values unlockable at the game level being determined based on an object identifier of the game object; and obtaining a first standby piece in the at least one standby piece in response to a trigger operation for piece information of the first standby piece.

### CROSS-REFERENCE TO RELATED APPLICATION

This application is a continuation application of PCT Patent Application No. PCT/CN2025/082939, entitled “METHOD AND APPARATUS FOR OBTAINING PIECE IN TURN-BASED BOARD GAME, DEVICE, AND STORAGE MEDIUM” filed on Mar. 17, 2025, which claims priority to Chinese Patent Application 202410573108.3, entitled “METHOD AND APPARATUS FOR OBTAINING PIECE IN TURN-BASED BOARD GAME, DEVICE, AND STORAGE MEDIUM” filed on May 9, 2024, both of which are incorporated herein by reference in their entirety.

### FIELD OF THE TECHNOLOGY

Embodiments of this application relate to the field of human-computer interaction technologies, and in particular, to a method and an apparatus for obtaining a piece in a turn-based board game, a device, and a storage medium.

### BACKGROUND OF THE DISCLOSURE

A turn-based board game is a new type of board game. After two parties of a battle place pieces on a board, a game application automatically controls the pieces of the two parties on the board to battle against each other, and displays a battle result.

### SUMMARY

Embodiments of this application provide a method and an apparatus for obtaining a piece in a turn-based board game, a device, and a storage medium, and can improve a matching degree between an obtained piece and a game requirement of a game object, thereby improving a human computer interaction rate. The technical solutions are as follows:

According to a first aspect, an embodiment of this application provides a method for obtaining a piece in a turn-based board game performed by a computer device, and the method including:
displaying a battle preparation interface for the turn-based board game, the battle interface including a battle preparation region and a board region;
in response to a user selection of the battle preparation region, transmitting a piece obtaining request to a server in an i^{th} turn of the turn-based board game, the piece obtaining request comprising an object identifier of the game object, and i being an integer greater than 1;
displaying piece information of at least one standby piece in the battle preparation interface, wherein any standby piece has a target resource value determined from resource values unlockable at a game level of the game object based on battle information of the game object in an (i−1)^{th} turn and the object identifier of the game object; and
in response to a trigger operation for piece information of a first standby piece on the battle preparation interface, adding the first standby piece to the battle preparation region.

According to a second aspect, an embodiment of this application provides a computer device, including a processor and a memory, the memory having at least one program code stored therein, and the at least one program code being loaded and executed by the processor, to enable the computer device to implement the foregoing method for obtaining a piece in a turn-based board game.

According to a third aspect, a non-transitory computer-readable storage medium is further provided, having at least one program code stored therein, the at least one program code being loaded and executed by a processor of a computer device, to enable the computer device to implement any one of the foregoing methods for obtaining a piece in a turn-based board game.

In the technical solutions provided in the embodiments of this application, when obtaining a piece in the i^{th} turn, the game object transmits the piece obtaining request to the server, so that the server determines the resource values unlockable at the game level of the game object based on the object identifier of the game object, and determines the target resource value from the resource values unlockable at the game level based on the battle information of the game object in the (i−1)^{th} turn, to further transmit the target resource value to the terminal device. In this way, the terminal device displays the piece information of the standby piece whose resource value is the target resource value, so that the game object selects and obtains a desired piece from the standby pieces. In this method, when the target resource value is determined, not only the game level of the game object is considered, but also the battle information of the game object in the previous turn is considered. Because the considered information is comprehensive, the determined target resource value better conforms to an actual battle situation of the game object. Because the resource value of the standby piece is the target resource value, a matching degree between the subsequently obtained piece and a game requirement of the game object is high, so that the game object obtains the desired piece can be improved, and fun of obtaining the piece can be improved, thereby improving game experience of the game object, and improving a human computer interaction rate.

In addition, because the target resource value returned by the server to the terminal device is determined from the unlockable resource values based on the battle information of the game object in the previous turn, the game object can manage the battle information in the previous turn to affect a process of determining the target resource value, so that game-theoretic fun can be brought to the game object, and a game control degree of the game object can be improved, thereby further improving a probability that the game object can obtain a desired piece in each turn, and further improving the human computer interaction rate.

### BRIEF DESCRIPTION OF THE DRAWINGS

FIG. 1 is a block diagram of a structure of a computer system according to an embodiment of this application.

FIG. 2 is a flowchart of a method for obtaining a piece in a turn-based board game according to an embodiment of this application.

FIG. 3 is a schematic diagram of display of a battle preparation page of the 1st turn in a turn-based board game according to an embodiment of this application.

FIG. 4 is a schematic diagram of display of a reference resource value according to an embodiment of this application.

FIG. 5 is a schematic diagram of display of piece information of a first piece according to an embodiment of this application.

FIG. 6 is a schematic diagram of display of first prompt information according to an embodiment of this application.

FIG. 7 is a schematic diagram of display of a battle preparation page of an i^{th} turn in a turn-based board game according to an embodiment of this application.

FIG. 8 is a schematic diagram of display of a target resource value and adjusted obtaining probabilities of resource values according to an embodiment of this application.

FIG. 9 is a schematic diagram of other display of a target resource value and adjusted obtaining probabilities of resource values according to an embodiment of this application.

FIG. 10 is a schematic diagram of still other display of a target resource value and adjusted obtaining probabilities of resource values according to an embodiment of this application.

FIG. 11 is a schematic diagram of display of piece information of a standby piece according to an embodiment of this application.

FIG. 12 is a schematic diagram of display of third prompt information according to an embodiment of this application.

FIG. 13 is a flowchart of a method for obtaining a piece in a turn-based board game according to an embodiment of this application.

FIG. 14 is a flowchart of a method for obtaining a piece in a turn-based board game according to an embodiment of this application.

FIG. 15 is a flowchart of a method for obtaining a piece in a turn-based board game according to an embodiment of this application.

FIG. 16 is a schematic diagram of a structure of an apparatus for obtaining a piece in a turn-based board game according to an embodiment of this application.

FIG. 17 is a schematic diagram of a structure of an apparatus for obtaining a piece in a turn-based board game according to an embodiment of this application.

FIG. 18 is a schematic diagram of a structure of a terminal device according to an embodiment of this application.

FIG. 19 is a schematic diagram of a structure of a server according to an embodiment of this application.

### DESCRIPTION OF EMBODIMENTS

To make the objectives, technical solutions, and advantages of this application clearer, the following further describes implementations of this application in detail with reference to the accompanying drawings.

The terms “first”, “second”, and the like in this application are intended to distinguish similar objects but not intended to necessarily indicate a specific order or sequence. Such used terms are interchangeable where appropriately, so that embodiments of this application described herein can be implemented in an order other than those illustrated or described herein. The implementations described in the following exemplary embodiments do not indicate all implementations consistent with this application. On the contrary, the implementations are merely examples of an apparatus and a method that are consistent with some aspects of this application described in detail in the claims.

First, terms involved in the embodiments of this application are described.

Turn-based board game: The turn-based board game refers to a board game in which “pieces” are arranged in advance before a battle begins, and during the battle, the “pieces” automatically battle based on a pre-determined arrangement. The “piece” is usually represented by a virtual character, and for example, may be referred to as a virtual hero. During the battle, the virtual character automatically casts various skills for the battle. The battle is usually turn-based. When all “pieces” of one party in the battle are eliminated (that is, health points of a virtual character drop to zero), the party is a loser of the battle of this turn. In some embodiments, the virtual character may also be referred to as a virtual object. In some embodiments, in addition to “piece-type virtual characters” engaging in battle, both parties of the battle are respectively provided with one chess player character representing a current user engaging in battle. The chess player character cannot be moved to a battle region or a candidate piece region as a “piece”. The chess player character also has health points (or hit points). The health points of the chess player character are correspondingly reduced (when the chess player character loses the battle) or not changed (when the chess player character wins the battle) based on a battle result of each turn. When the health points of the chess player character drop to zero, the user corresponding to the chess player character exits the battle, and the remaining users continue the battle. In some embodiments, the turn-based board game includes an auto battler. In some embodiments, the user may also be referred to as a player, a game object, or the like.

Auto battler: The auto battler is an in-game collectible hero-piece multiplayer turn-based competitive game. For example, there are eight or six players in total in a game, and each occupies a region on a board. Two of the plurality of players engage in one-to-one battle. Each turn of a battle includes a battle preparation stage and a battle stage. The battle preparation stage is configured for purchasing a piece (hero) in a shop and performing arrangement on the board. In the battle stage, formations of the two parties are locked, and pieces automatically battle with each other until all pieces of one party are eliminated. The party whose pieces are all eliminated is a defeated party of the current turn, and is deducted by a specific amount of hit points. Game turns are continuously repeated and new opponents are matched until a player is eliminated when health points of the player are less than or equal to (≤) 0. A last survived player (the 1^{st} place) wins the game.

Board: The board is a region for battle preparation and battle on a battle interface in a turn-based board game. The board may be any one of a two-dimensional virtual board, a 2.5-dimensional virtual board, and a three-dimensional virtual board. This is not limited in this application.

A board of a conventional auto battler is divided into a battle region and a candidate piece region. The battle region includes several tiles having the same size. The tile is configured for placing a piece for a battle in a battle process. The candidate piece region includes several candidate piece positions. The candidate piece position is configured for placing a candidate piece. The candidate piece does not participate in the battle in the battle process, and can be dragged and placed in the battle region in a battle preparation stage. Regions of a board provided in the embodiments of this application do not include the candidate piece region, and include only the battle region.

For an arrangement manner of tiles in the battle region, in some embodiments, the battle region includes n (rows)× m (columns) tiles. For example, n is an integer multiple of 2, and two adjacent rows of tiles are aligned or staggered. In addition, the battle region is evenly divided into two parts based on the rows, which are respectively an allied battle region and an enemy battle region. Users participating in the battle are respectively located on an upper side and a lower side of the battle interface, and the user can place a piece in the allied battle region in the battle preparation stage. In some other embodiments, the battle region is evenly divided into two parts based on the columns, which are respectively an allied battle region and an enemy battle region. Users participating in the battle are respectively located on a left side and a right side, or an upper side and a lower side, of the battle interface A shape of the tile may be any one of a square, a rectangle, a circle, and a hexagon. The shape of the tile is not limited in the embodiments of this application.

Card: The card is a common term of a game type, and derives from a tabletop game. Different from a chess in which a piece model is directly operated, the card bears content in a game. In comparison with a piece, it is more convenient to bear some text descriptions, card attribute information, and transmission of some key values on the card. In addition, “cardification” refers to making a hero resource into a card resource, so that it is convenient for a player to read and classify a card effect, and information transmission in more dimensions are borne.

Energy: The energy is a game resource mode. However, in this application, the energy can be defined as a resource for playing a card by a player. When a card is played, energy of a corresponding value marked on the card needs to be consumed.

Equipment: In an auto battler game, each piece can wear three pieces of equipment (or another quantity of pieces of equipment), and the equipment can provide a hero with an infusion: an attribute or effect such as an attack power, a defense power, health points, healing, penetration, a shield. The auto battler game usually includes a creep turn in which a player obtains equipment dropped by a creep after defeating the creep and picks the equipment to a backpack. Equipment components may further be combined to obtain equipment of higher quality.

Chess player: The chess player is a virtual character played by a player. Each chess player has a different special ability, which can help the player play a game better. In some embodiments, the chess player may also be referred to as a chess player virtual character, a chess player character, or the like.

In a related technology, a game object can purchase a piece from a game shop in each turn of a turn-based board game. A target resource value unlockable by the game object is determined based on a game level of the game object, and candidate pieces whose resource values are the target resource value are displayed in the game shop. The game object can select and purchase a desired piece from the candidate pieces. For example, if the game level of the game object is level 1, and the target resource value is 1, candidate pieces whose resource values are 1 are displayed in the game shop.

However, in the foregoing piece obtaining method, only the game level of the game object is considered when the target resource value is determined. As a result, information considered when the target resource value is determined is not comprehensive enough, randomness of the determined target resource value is high, and further, a matching degree between the candidate pieces displayed in the game shop and a game requirement of the game object is low.

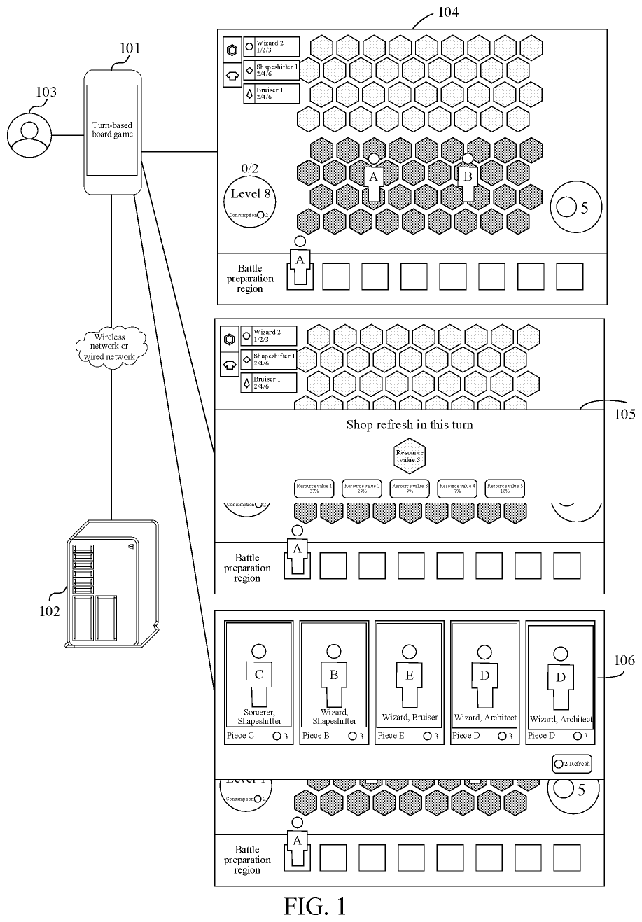

FIG. 1 is a block diagram of a structure of a computer system according to an exemplary embodiment of this application. As shown in FIG. 1, the computer system includes a terminal device 101 and a server 102. A turn-based board game is installed and run in the terminal device 101, and a game object 103 logs in to the turn-based board game. A method for obtaining a piece in a turn-based board game provided in the embodiments of this application may be performed by the terminal device 101, or may be jointly performed by the terminal device 101 and the server 102. This is not limited in the embodiments of this application.

The server 102 is configured to provide a background service for the turn-based board game installed in the terminal device 101. In an implementation, the server 102 takes primary computing work, and the terminal device 101 takes secondary computing work. Alternatively, the server 102 takes secondary computing work, and the terminal device 101 takes primary computing work. Alternatively, collaborative computing is performed between the terminal device 101 and the server 102 through a distributed computing architecture.

In some embodiments, the terminal device 101 may be any electronic device product that may perform human-computer interaction with a user in one or more manners such as a keyboard, a touch pad, a remote control, voice interaction, or a handwriting device. For example, the terminal device 101 may be a smartphone, a tablet computer, a notebook computer, a desktop computer, a smart speaker, a smartwatch, a personal computer (PC), a mobile phone, a personal digital assistant (PDA), a wearable device, a pocket PC (PPC), smart in-vehicle infotainment, or a smart television.

The terminal device 101 may refer to one of a plurality of terminal devices. In this embodiment, only the terminal device 101 is used as an example for description. A person skilled in the art can learn that there may be more or fewer terminal devices 101. For example, there is only one terminal device 101, or there are dozens or hundreds of terminal devices 101, or more terminal devices 101. A quantity of terminal devices 101 and a device type are not limited in the embodiments of this application.

The server 102 is one server, a server cluster including a plurality of servers, or either of a cloud computing platform or a virtualization center. This is not limited in the embodiments of this application. The server 102 and the terminal device 101 are communicatively connected directly or indirectly through wired communication or wireless communication. The server 102 has a data receiving function, a data processing function, and a data transmission function. Certainly, the server 102 may further have another function. This is not limited in the embodiments of this application.

In an exemplary embodiment of this application, according to the method for obtaining a piece in a turn-based board game provided in the embodiments of this application, the terminal device 101 displays a battle preparation page 104 of an i^{th} turn of a turn-based board game, and transmits a piece obtaining request to the server 102 in a battle preparation stage of the i^{th} turn. After receiving the piece obtaining request, the server 102 determines resource values unlockable at a game level of a game object and obtaining probabilities of the resource values, adjusts the obtaining probabilities of the resource values based on battle information of the game object in an (i−1)^{th} turn, to obtain adjusted obtaining probabilities of the resource values, determines a target resource value from the resource values based on the adjusted obtaining probabilities of the resource values, and further transmits the target resource value to the terminal device 101. After receiving the target resource value, the terminal device 101 displays a first page 105, the target resource value being displayed in the first page 105. When display duration of the target resource value is not less than a duration threshold, the terminal device 101 displays a second page 106, the second page 106 displaying piece information of at least one standby piece, and a resource value of each standby piece being the target resource value. The terminal device 101 obtains a first standby piece in response to a trigger operation for the first standby piece, that is, the game object obtains the first standby piece.

A person skilled in the art is to understand that the terminal device 101 and the server 102 are only examples for description, and other existing or future possible terminal devices or servers that are applicable to this application are also to be included in the protection scope of this application, and are included herein by reference.

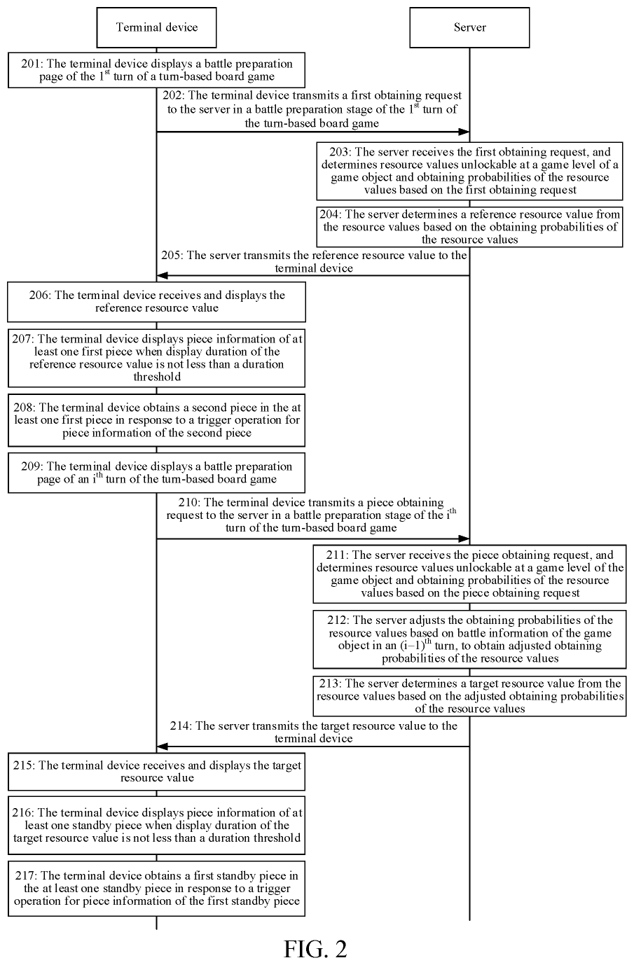

An embodiment of this application provides a method for obtaining a piece in a turn-based board game. The method is applicable to the computer system shown in FIG. 1. Using a flowchart of a method for obtaining a piece in a turn-based board game according to an embodiment of this application shown in FIG. 2 as an example, the method may be implemented through interaction between the terminal device 101 and the server 102 in FIG. 1. As shown in FIG. 2, the method includes the following operation 201 to operation 217.

Operation 201: A terminal device displays a battle preparation page of the 1^{st} turn of a turn-based board game.

In an implementation, the turn-based board game is installed in the terminal device. For example, the turn-based board game may be an auto battler game. Information related to the turn-based board game is displayed on a display interface of the terminal device. The information related to the turn-based board game may be a name of the turn-based board game, an icon of the turn-based board game, or other information of the turn-based board game. This is not limited in this embodiment of this application.

When intending to run the turn-based board game, a game object selects the information related to the turn-based board game. The terminal device receives a trigger operation for the information related to the turn-based board game, and displays a home page of the turn-based board game. A start control is displayed in the home page of the turn-based board game, and is configured for starting a round of game. In response to a trigger operation for the start control, a battle preparation stage of the 1^{st} turn of the turn-based board game starts, and the battle preparation page of the 1^{st} turn of the turn-based board game is displayed. The game object may obtain a piece in the battle preparation page of the 1^{st} turn of the turn-based board game, and determine a piece that needs to be used in a battle stage of the 1^{st} turn of the turn-based board game.

In an implementation, the battle preparation page of the 1^{st} turn of the turn-based board game includes a battle preparation region and a board region. A virtual object corresponding to a piece already possessed by the game object is displayed in the battle preparation region. The game object may drag the virtual object corresponding to the piece in the battle preparation region to the board region. The virtual object corresponding to the dragged piece is displayed in the board region. The virtual object corresponding to the piece dragged to the board region is a virtual object that needs to be used by the game object in the battle stage of the 1^{st} turn.

In some embodiments, a game level of the game object may further be displayed in the battle preparation page of the 1^{st} turn of the turn-based board game, and the game object learns the game level of the game object through the display of the game level of the game object.

In some embodiments, a value of resources that need to be consumed to increase the level by one level may further be displayed in the battle preparation page of the 1^{st} turn of the turn-based board game. The resource is a game resource in the turn-based board game. For example, the resource may be a diamond or a gold.

In some embodiments, a value of resources already possessed by the game object may further be displayed in the battle preparation page of the 1^{st} turn of the turn-based board game. The value of the resources already possessed by the game object may be a value of resources included in an account of the game object in the turn-based board game.

Other information may be further displayed in the battle preparation page of the 1^{st} turn of the turn-based board game. This is not limited in this embodiment of this application.

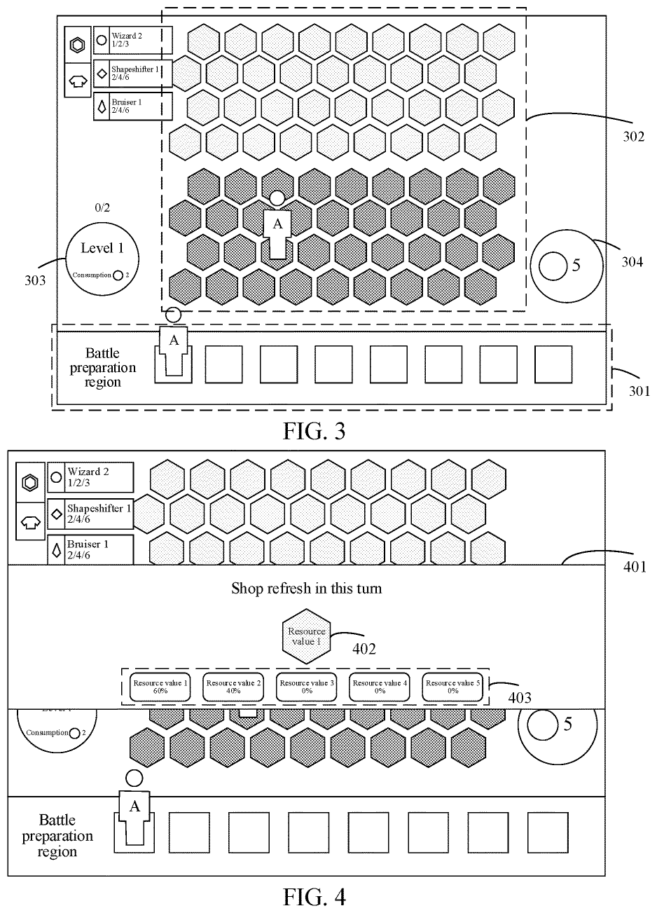

FIG. 3 is a schematic diagram of display of a battle preparation page of the 1^{st} turn in a turn-based board game according to an embodiment of this application. In FIG. 3, 301 is a battle preparation region, and 302 is a board region. “Level 1” in 303 in FIG. 3 is a game level of a game object, and “2” in 303 in FIG. 3 is a value of resources that need to be consumed to increase the level by one level. In other words, 303 in FIG. 3 indicates that the value of the resources that need to be consumed to increase the game level of the game object from level 1 to level 2 is 2, that is, two resources need to be consumed to increase the game level of the game object from level 1 to level 2. “5” in 304 in FIG. 3 is a value of resources already possessed by the game object, in other words, 304 in FIG. 3 indicates that the game object already possesses five resources.

Operation 202: The terminal device transmits a first obtaining request to a server in the battle preparation stage of the 1^{st} turn of the turn-based board game.

In an implementation, the game object may obtain a new piece in a battle preparation stage of each turn of the turn-based board game, to use the new piece in a battle stage of the corresponding turn. In some embodiments, the terminal device generates the first obtaining request and transmits the first obtaining request to the server when display duration of the battle preparation page of the 1^{st} turn of the turn-based board game is not less than target duration in the battle preparation stage of the 1^{st} turn of the turn-based board game. The first obtaining request includes an object identifier of the game object.

For example, the target duration is set based on experience or adjusted based on an implementation environment. This is not limited in this embodiment of this application. For example, the target duration is three seconds. The object identifier of the game object is configured for uniquely identifying the game object. For example, the object identifier of the game object may be the game account of the game object in the turn-based board game, or a game nickname of the game object in the turn-based board game. This is not limited in this embodiment of this application.

In an implementation, the terminal device generates the first obtaining request and transmits the first obtaining request to the server in response to display of the battle preparation page of the 1^{st} turn in the battle preparation stage of the 1^{st} turn of the turn-based board game. In other words, the first obtaining request is generated immediately after the battle preparation page of the 1^{st} turn is displayed, to improve efficiency of obtaining a piece in the battle preparation stage of the 1^{st} turn.

In an implementation, a piece obtaining control is displayed in the battle preparation page of the 1^{st} turn of the turn-based board game in the battle preparation stage of the 1^{st} turn of the turn-based board game. The terminal device generates the first obtaining request in response to a trigger operation on the piece obtaining control, and transmits the first obtaining request to the server. The terminal device generates the first obtaining request based on the active trigger operation of the game object, to help improve a matching degree between a process of generating the first obtaining request and a requirement of the game object.

Operation 203: The server receives the first obtaining request, and determines resource values unlockable at the game level of the game object and obtaining probabilities of the resource values based on the first obtaining request.

In an implementation, the server receives the first obtaining request transmitted by the terminal device, and parses the first obtaining request, to obtain the object identifier of the game object. A game level of each object and a correspondence between an object identifier of each object and the game level are stored in the server. The server determines the game level of the game object based on the object identifier of the game object and the correspondence between the object identifier of each object and the game level. The game level of each object is determined based on game performance (such as a battle result or a value of possessed resources) of each object in the turn-based board game. A rule for determining the game level of each object may be set by a developer of the turn-based board game. This is not limited in this embodiment of this application. As the game performance of each object in the turn-based board game continuously changes, the game level of each object may continuously change, and the server stores a currently latest game level of each object. For example, the server determines that the game level of the game object is level 1.

The server further stores a correspondence between the game level and the resource values unlockable at the game level. One or more resource values are unlockable at each game level. Quantities of resource values unlockable at different game levels may be the same or different. At least one resource value is different in the resource values unlockable at different game levels. For example, a higher game level indicates a larger maximum resource value in resource values unlockable at the game level. The following table 1 is a table of correspondences between game levels and resource values unlockable at the game levels provided in this embodiment of this application.

TABLE 1

| Game level | Resource value unlockable at the game level |
|---|---|
| Level 1 and | Resource value 1 and resource value 2 |
| level 2 | |
| Level 3 and | Resource value 1, resource value 2, and |
| level 4 | resource value 3 |
| Level 5 and | Resource value 1, resource value 2, resource |
| level 6 | value 3, and resource value 4 |
| Level 7 and | Resource value 1, resource value 2, resource |
| higher | value 3, resource value 4, and |
| | resource value 5 |

It can be learned from Table 1 that, when the game level is level 1 or level 2, the unlockable resource values are the resource value 1 and the resource value 2; when the game level is level 3 or level 4, the unlockable resource values are the resource value 1, the resource value 2, and the resource value 3; when the game level is level 5 or level 6, the unlockable resource values are the resource value 1, the resource value 2, the resource value 3, and the resource value 4; and when the game level is level 7 or higher, the unlockable resource values are the resource value 1, the resource value 2, the resource value 3, the resource value 4, and the resource value 5.

For example, when the server determines that the game level of the game object is level 1, the resource values unlockable at the game level of the game object are the resource value 1 and the resource value 2.

In some embodiments, the server further stores a correspondence between the resource values unlockable at the game level and obtaining probabilities of the resource values unlockable at the game level. For example, when the game level is level 1 or level 2, the unlockable resource values are the resource value 1 and the resource value 2, where an obtaining probability of the resource value 1 is 60%, and an obtaining probability of the resource value 2 is 40%. When the game level is level 3 or level 4, the unlockable resource values are the resource value 1, the resource value 2, and the resource value 3, where an obtaining probability of the resource value 1 is 55%, an obtaining probability of the resource value 2 is 38%, and an obtaining probability of the resource value 3 is 7%. When the game level is level 5 or level 6, the unlockable resource values are the resource value 1, the resource value 2, the resource value 3, and the resource value 4, where an obtaining probability of the resource value 1 is 50%, an obtaining probability of the resource value 2 is 35%, an obtaining probability of the resource value 3 is 10%, and an obtaining probability of the resource value 4 is 5%. When the game level is level 7 or higher, the unlockable resource values are the resource value 1, the resource value 2, the resource value 3, the resource value 4, and the resource value 5, where an obtaining probability of the resource value 1 is 40%, an obtaining probability of the resource value 2 is 32%, an obtaining probability of the resource value 3 is 12%, an obtaining probability of the resource value 4 is 10%, and an obtaining probability of the resource value 5 is 6%.

A sum of obtaining probabilities of resource values unlockable at any game level is 1.

For example, when the server determines that the game level of the game object is level 1, the resource values unlockable at the game level of the game object are the resource value 1 and the resource value 2, where an obtaining probability of the resource value 1 is 60%, and an obtaining probability of the resource value 2 is 40%.

Resource values unlockable at any game level are set based on experience or adjusted based on an implementation environment. This is not limited in this embodiment of this application. In some embodiments, resource values unlockable at any game level are set by the developer of the turn-based board game. Obtaining probabilities of resource values unlockable at any game level are set based on experience or adjusted based on an implementation environment. This is not limited in this embodiment of this application. In some embodiments, obtaining probabilities of resource values unlockable at any game level are set by the developer of the turn-based board game.

Operation 204: The server determines a reference resource value from the resource values based on the obtaining probabilities of the resource values.

In an implementation, after the obtaining probabilities of the resource values unlockable at the game level are determined in operation 203, the reference resource value is determined from the resource values based on the obtaining probabilities of the resource values.

An obtaining probability of any resource value is a probability that the resource value is determined as the reference resource value. For example, when the obtaining probability of the resource value 1 is 60%, it indicates that a probability that the resource value 1 is determined as the reference resource value is 60%; and when the obtaining probability of the resource value 2 is 40%, it indicates that a probability that the resource value 2 is determined as the reference resource value is 40% A higher obtaining probability of any resource value indicates a higher probability that the resource value is determined as the reference resource value. On the contrary, a lower obtaining probability of any resource value indicates a lower probability that the resource value is determined as the reference resource value.

A process of determining the reference resource value from the resource values based on the obtaining probabilities of the resource values is not limited in this embodiment of this application, provided that it is ensured that a probability that any one of the resource values is determined as the reference resource value is an obtaining probability of the resource value. In some embodiments, an application program configured to determine the resource values is run in the server. The server inputs each resource value and an obtaining probability of each resource value into the application program, and obtains the reference resource value based on an output result of the application program. In other words, the output result of the application program is used as the reference resource value.

For example, the reference resource value determined by the server from the resource values based on the obtaining probabilities of the resource values is the resource value 1.

Operation 205: The server transmits the reference resource value to the terminal device.

In an implementation, after determining the reference resource value in operation 204, the server transmits the reference resource value to the terminal device, so that the terminal device displays the reference resource value.

In some embodiments, after determining the obtaining probabilities of the resource values in operation 203, the server may further transmit the obtaining probabilities of the resource values to the terminal device, so that the terminal device displays the obtaining probabilities of the resource values, and further, the game object learns the obtaining probabilities of the resource values unlockable at the current game level of the game object.

The server may simultaneously transmit the reference resource value and the obtaining probabilities of the resource values to the terminal device. Alternatively, the server may first transmit the reference resource value to the terminal device, and then transmit the obtaining probabilities of the resource values to the terminal device. Alternatively, the server may first transmit the obtaining probabilities of the resource values to the terminal device, and then transmit the reference resource value to the terminal device. A transmitting sequence of the reference resource value and the obtaining probabilities of the resource values is not limited in this embodiment of this application.

Operation 206: The terminal device receives and displays the reference resource value.

In an implementation, the terminal device receives the reference resource value transmitted by the server, and displays the reference resource value. The reference resource value is configured for indicating a resource value of a piece available to the game object in the 1^{st} turn. The reference resource value is displayed, so that the game object can learn the resource value of the piece obtainable in the 1^{st} turn.

In some embodiments, a process of displaying the reference resource value includes: displaying a third page in the battle preparation page of the 1^{st} turn, the reference resource value being displayed in the third page. A position of the third page in the battle preparation page of the 1^{st} turn may be set based on experience or adjusted based on an implementation environment. This is not limited in this embodiment of this application. For example, the position of the third page in the battle preparation page of the 1^{st} turn may be a center position, a top position, or a bottom position in the battle preparation page of the 1^{st} turn.

FIG. 4 is a schematic diagram of display of a reference resource value according to an embodiment of this application. In FIG. 4, a third page 401 is displayed in the battle preparation page of the 1^{st} turn, and a reference resource value 402 is displayed in the third page 401.

In an implementation, the terminal device may further receive the obtaining probabilities of the resource values transmitted by the server, and display the obtaining probabilities of the resource values. In this way, the game object can learn the obtaining probabilities of the resource values unlockable at the current game level of the game object. In some embodiments, the obtaining probabilities of the resource values are displayed in the third page. In some embodiments, the obtaining probabilities of the resource values are displayed in a page different from the third page in the battle preparation page of the 1^{st} turn. In other words, the reference resource value and the obtaining probabilities of the resource values may be displayed in two different pages in the battle preparation page of the 1^{st} turn.

For example, using an example in which the obtaining probabilities of the resource values are displayed in the third page, the obtaining probabilities of the resource values are displayed in 403 in the third page 401 in FIG. 4.

Operation 207: The terminal device displays piece information of at least one first piece when display duration of the reference resource value is not less than a duration threshold.

Because the reference resource value is displayed in the third page, the display duration of the reference resource value is not less than the duration threshold refers to that display duration of the third page is not less than the duration threshold. The duration threshold is set based on experience or adjusted based on an implementation environment. This is not limited in this embodiment of this application. For example, the duration threshold is three seconds.

When the display duration of the third page is not less than the duration threshold, the terminal device cancels display of the third page, and displays the piece information of the at least one first piece. A quantity of the at least one first piece may be set based on experience or adjusted based on an implementation environment. This is not limited in this embodiment of this application. Piece information of any first piece is information associated with any piece. For example, the piece information includes, but is not limited to, an image of a virtual object corresponding to the piece, a name of the piece, a type of the virtual object corresponding to the piece, and a resource value of the piece. A resource value of any first piece is the reference resource value.

A manner of displaying the piece information of the at least one first piece is not limited in this embodiment of this application. In some embodiments, the terminal device displays a fourth page in the battle preparation page of the 1^{st} turn, the piece information of the at least one first piece being displayed in the fourth page. For example, because a display region of the fourth page is limited, a quantity of first pieces displayed in the fourth page needs to be limited. For example, the quantity of the first pieces displayed in the fourth page is not greater than a target quantity. The target quantity is set based on experience or adjusted based on an implementation environment. This is not limited in this embodiment of this application. For example, the target quantity is 5. In other words, when the piece information of the at least one first piece is displayed in the fourth page, the quantity of the at least one first piece is not greater than the target quantity.

FIG. 5 is a schematic diagram of display of piece information of a first piece according to an embodiment of this application. In FIG. 5, a fourth page 501 is displayed in the battle preparation page of the 1^{st} turn, and piece information of five first pieces is displayed in the fourth page 501. A name of the 1^{st} first piece is a piece w, a type of a virtual object corresponding to the 1^{st} first piece is Sorcerer and Shapeshifter, and a resource value of the 1^{st} first piece is 1. Piece information of the other first pieces is shown in FIG. 5, and details are not described herein.

In an implementation, before the piece information of the at least one first piece is displayed, the piece information of the at least one first piece needs to be obtained first. A manner of obtaining the piece information of the at least one first piece is not limited in this embodiment of this application. In some embodiments, the following two manners of obtaining the piece information of the at least one first piece are provided in this embodiment of this application.

Obtaining manner 1: Receive the piece information of the at least one first piece that is transmitted by the server.

In the obtaining manner 1, after determining the reference resource value in operation 204, the server determines the at least one first piece based on the reference resource value, obtains the piece information of the first piece, and further transmits the piece information of the first piece to the terminal device, so that the terminal device obtains the piece information of the first piece.

A process in which the server determines the at least one first piece based on the reference resource value is similar to a process in which the terminal device determines the at least one first piece based on the reference resource value in the following obtaining manner 2. For details, refer to the following descriptions of the obtaining manner 2, and details are not described herein.

In the manner in which the server determines the first piece and transmits the piece information of the first piece to the terminal device, because the terminal device does not need to determine the first piece, resources of the terminal device can be saved, and a computational load of the terminal device can be reduced.

Obtaining manner 2: The terminal device determines the at least one first piece based on the reference resource value, and obtains the piece information of the at least one first piece.

In the obtaining manner 2, after receiving the reference resource value transmitted by the server in operation 206, the terminal device determines the at least one first piece based on the reference resource value, and further obtains the piece information of the at least one first piece.

For example, the process in which the terminal device determines the at least one first piece based on the reference resource value includes: The terminal device uses, as a first selectable piece, a piece whose resource value is the reference resource value in candidate pieces, and determines the at least one first piece from the first selectable piece. In some embodiments, first selectable pieces of a target quantity are determined from the first selectable piece as the at least one first piece.

A manner in which the terminal device determines the standby piece and the piece information of the standby piece is beneficial to reducing a computational pressure of the server.

In some embodiments, after the terminal device displays the piece information of the at least one first piece, the method further includes: The terminal device displays, in response to a refresh operation within a duration threshold (e.g., 2 seconds), piece information of a piece after the refresh, a resource value of the piece after the refresh being the reference resource value. The refresh operation is configured for refreshing the at least one first piece. After the piece information of the at least one first piece is displayed, refreshing the displayed piece based on the refresh operation of the game object is further supported, to help improve a matching degree between the displayed piece and a game requirement of the game object, so that a probability that the game object obtains a desired piece is improved, and fun of obtaining the piece is improved, thereby improving game experience of the game object, and improving a human computer interaction rate.

A type of the refresh operation is not limited in this application. For example, the refresh operation may be a trigger operation for a refresh control, a voice configured for indicating refreshing, or a gesture configured for indicating refreshing.

For example, using an example in which the piece information of the at least one first piece is displayed in the fourth page, a refresh control is further displayed in the fourth page, the refresh control being configured for refreshing the displayed first piece. In this case, displaying, in response to a refresh operation, piece information of a piece after the refresh may include: displaying the piece information of the piece after the refresh in the fourth page in response to a trigger operation for the refresh control, a resource value of the piece after the refresh being the reference resource value.

In an exemplary embodiment, a quantity of pieces after the refresh is the same as a quantity of the at least one first piece. The piece after the refresh may be completely the same as the at least one first piece, or may not be completely the same as the at least one first piece.

Before the piece information of the piece after the refresh is displayed in the fourth page, the piece information of the piece after the refresh needs to be obtained first. A process of obtaining the piece information of the piece after the refresh is similar to the process of obtaining the piece information of the first piece. For details, refer to the process of obtaining the piece information of the first piece. Details are not described herein again in this embodiment of this application.

For example, a value of resources required for refreshing may be displayed on the refresh control. In response to the trigger operation for the refresh control, the value of the resources required for refreshing is deducted from the account of the game object.

For example, a refresh control 502 is displayed in the fourth page 501 in FIG. 5. “2” displayed on the refresh control 502 indicates that two resources are required for refreshing once. Therefore, in response to a trigger operation for the refresh control 502, two resources are deducted from the account of the game object.

Operation 208: The terminal device obtains a second piece in the at least one first piece in response to a trigger operation for piece information of the second piece.

After the piece information of the at least one first piece is displayed, the game object may select and purchase one piece from the first piece, that is, obtain one piece. The second piece is any one of the at least one first piece.

In some embodiments, a process in which the terminal device obtains the second piece in the at least one first piece in response to the trigger operation for the piece information of the second piece is similar to the following process in which a terminal device obtains a first standby piece in at least one standby piece in response to a trigger operation for piece information of the first standby piece. For details, refer to the following process in which the terminal device obtains the first standby piece. Details are not described herein in this embodiment of this application.

The terminal device obtains the second piece, that is, the game object obtains the second piece, so that the game object can select, in the battle preparation page of the 1^{st} turn, a piece that needs to be used in the battle stage of the 1^{st} turn, and then enter the battle stage of the 1^{st} turn. After the battle stage of the 1^{st} turn ends, first prompt information is displayed in a battle page of the 1^{st} turn. The first prompt information is configured for indicating a battle result of the game object in the 1^{st} turn. Then, the game object enters a battle preparation stage of the 2^{nd} turn. The first prompt information may be any content that can indicate the battle result of the game object in the 1^{st} turn. This is not limited in this embodiment of this application.

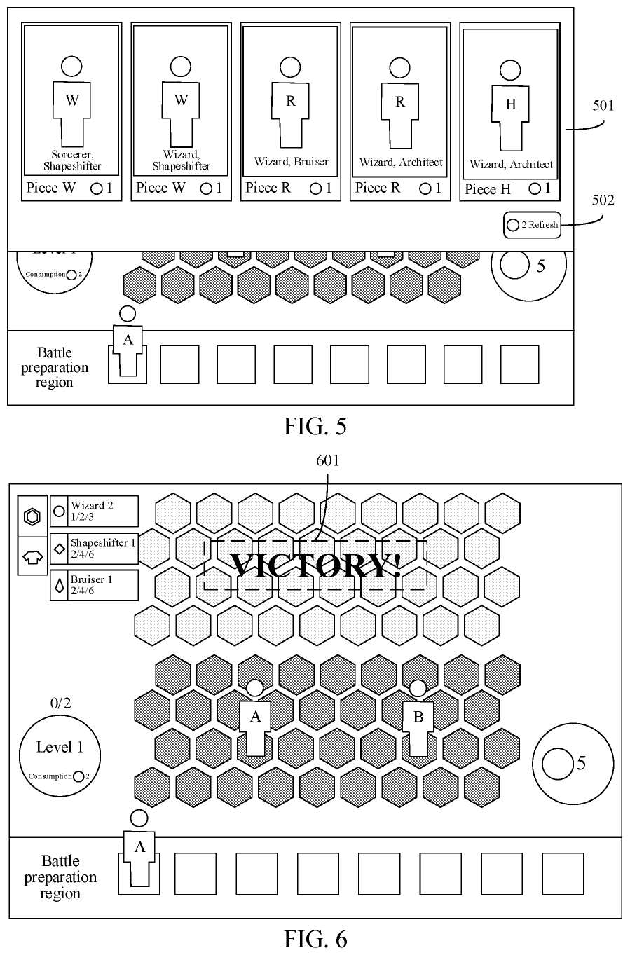

FIG. 6 is a schematic diagram of display of first prompt information according to an embodiment of this application. In FIG. 6, first prompt information 601 is displayed in the battle page of the 1^{st} turn. Content of the first prompt information is “VICTORY!”. In other words, the battle result of the game object in the 1^{st} turn is a victory.

Operation 209: The terminal device displays a battle preparation page of an i^{th} turn of the turn-based board game.

i is an integer greater than 1, in other words, the battle preparation page of the i^{th} turn of the turn-based board game is a battle preparation page of a non-1^{st} turn of the turn-based board game.

In an implementation, content displayed in the battle preparation page of the i^{th} turn of the turn-based board game is similar to the content displayed in the battle preparation page of the 1^{st} turn of the turn-based board game in operation 201. Details are not described herein again in this embodiment of this application.

A game level of the game object displayed in a battle preparation page of each turn is a game level of the game object in a battle preparation stage of each turn, and a quantity of resources possessed by the account of the game object displayed in the battle preparation page of each turn is a quantity of resources possessed by the account of the game object in the battle preparation stage of each turn. The game level of the game object and the quantity of resources possessed by the account of the game object may change as turns of the turn-based board game progress. Therefore, game levels of the game object displayed in battle preparation pages of different turns may be the same or may be different. Quantities of resources possessed by the account of the game object displayed in battle preparation pages of different turns may be the same or may be different.

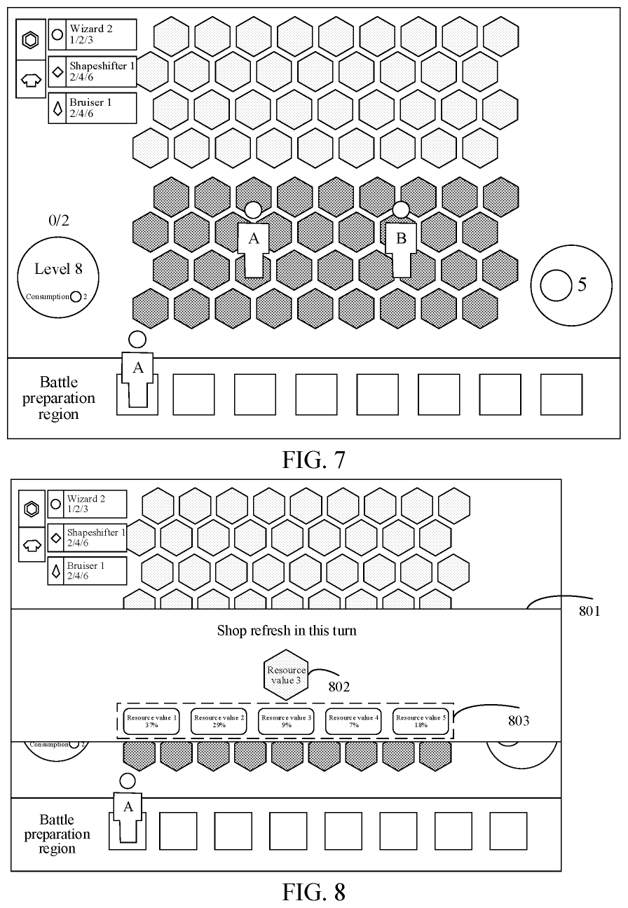

FIG. 7 is a schematic diagram of display of a battle preparation page of an i^{th} turn in a turn-based board game according to an embodiment of this application. It can be learned from FIG. 7 that the game level of the game object is level 8, and the quantity of resources possessed by the account of the game object is 5.

Operation 210: The terminal device transmits a piece obtaining request to the server in a battle preparation stage of the i^{th} turn of the turn-based board game.

In an implementation, the terminal device transmits the piece obtaining request to the server when display duration of the battle preparation page of the i^{th} turn of the turn-based board game is not less than the target duration in the battle preparation stage of the i^{th} turn of the turn-based board game. The piece obtaining request includes the object identifier of the game object.

In an implementation, the terminal device generates the piece obtaining request and transmits the piece obtaining request to the server in response to display of the battle preparation page of the i^{th} turn in the battle preparation stage of the i^{th} turn of the turn-based board game. In other words, the piece obtaining request is generated immediately after the battle preparation page of the i^{th} turn is displayed, to improve efficiency of obtaining a piece in the battle preparation stage of the i^{th} turn.

In an implementation, a piece obtaining control is displayed in the battle preparation page of the i^{th} turn of the turn-based board game in the battle preparation stage of the i^{th} turn of the turn-based board game. The terminal device generates the piece obtaining request in response to a trigger operation on the piece obtaining control, and transmits the piece obtaining request to the server. The terminal device generates the piece obtaining request based on the active trigger operation of the game object, to help improve a matching degree between a process of generating the piece obtaining request and the requirement of the game object.

Operation 211: The server receives the piece obtaining request, and determines resource values unlockable at a game level of the game object and obtaining probabilities of the resource values based on the piece obtaining request.

The server receives the piece obtaining request transmitted by the terminal device, parses the piece obtaining request to obtain the object identifier of the game object, determines the game level of the game object based on the object identifier of the game object, and further determines the resource values unlockable at the game level of the game object and the obtaining probabilities of the resource values. This process is similar to the process of the foregoing operation 203. Details are not described herein again.

The game level of the game object determined in operation 211 is a game level of the game object in the battle preparation stage of the i^{th} turn, and the game level of the game object determined in operation 203 is a game level of the game object in the battle preparation stage of the 1^{st} turn. The game level of the game object in the battle preparation stage of the i^{th} turn may be the same as or different from the game level of the game object in the battle preparation stage of the 1^{st} turn. If the game level of the game object in the battle preparation stage of the i^{th} turn is the same as the game level of the game object in the battle preparation stage of the 1^{st} turn, the resource values unlockable at the game level and the obtaining probabilities of the resource values that are determined in operation 211 are the same as the resource values unlockable at the game level and the obtaining probabilities of the resource values that are determined in operation 203. If the game level of the game object in the battle preparation stage of the i^{th} turn is different from the game level of the game object in the battle preparation stage of the 1^{st} turn, the resource values unlockable at the game level and the obtaining probabilities of the resource values that are determined in operation 211 are different from the resource values unlockable at the game level and the obtaining probabilities of the resource values that are determined in operation 203.

For example, the game level of the game object determined by the server based on the piece obtaining request is level 8, and the resource values unlockable at the game level of the game object are the resource value 1, the resource value 2, the resource value 3, the resource value 4, and the resource value 5, where an obtaining probability of the resource value 1 is 40%, an obtaining probability of the resource value 2 is 32%, an obtaining probability of the resource value 3 is 12%, an obtaining probability of the resource value 4 is 10%, and an obtaining probability of the resource value 5 is 6%.

Operation 212: The server adjusts the obtaining probabilities of the resource values based on battle information of the game object in an (i−1)^{th} turn, to obtain adjusted obtaining probabilities of the resource values.

Because the i^{th} turn is a non-1^{st} turn, after the obtaining probabilities of the resource values are determined, the obtaining probabilities of the resource values may be adjusted based on the battle information in a turn previous to the i^{th} turn, that is, the (i−1)^{th} turn, to obtain the adjusted obtaining probabilities of the resource values. In this way, the game object can control the obtaining probabilities of the resource values by controlling the battle information in the previous turn, to control an obtainable piece, thereby helping improve the game experience of the game object, and improve the human computer interaction rate.

In an implementation, the battle information of the game object in the (i−1)^{th} turn includes a battle result of the game object in the (i−1)^{th} turn, and the battle result of the game object in the (i−1)^{th} turn may be a victory or a failure. This is not limited in this embodiment of this application.

A process of adjusting the obtaining probabilities of the resource values based on the battle information of the game object in the (i−1)^{th} turn, to obtain the adjusted obtaining probabilities of the resource values includes the following operation 1 to operation 3.

Operation 1: Determine a first basic value matching the battle result of the game object in the (i−1)^{th} turn.

A first basic value when the battle result of the game object in the (i−1)^{th} turn is a victory may be the same as or different from a first basic value when the battle result of the game object in the (i−1)^{th} turn is a failure. This is not limited in this embodiment of this application.

For example, the first basic value when the battle result of the game object in the (i−1)^{th} turn is a victory and the first basic value when the battle result of the game object in the (i−1)^{th} turn is a failure are both 1.

Operation 2: Determine a second basic value based on a quantity of first resource values and the first basic value.

A process of determining the second basic value based on the quantity of first resource values and the first basic value includes: determining a product of the quantity of first resource values and the first basic value, to obtain the second basic value. For example, the quantity of first resource values is 4, and the first basic value is 1. In this case, the second basic value is 4*1=4.

The first resource value is a non-largest resource value in the resource values. For example, the resource values include the resource value 1, the resource value 2, the resource value 3, the resource value 4, and the resource value 5. In this case, the resource value 1, the resource value 2, the resource value 3, and the resource value 4 are the first resource values, and the quantity of first resource values is 4. For another example, the resource values include the resource value 1, the resource value 2, and the resource value 3. In this case, the resource value 1 and the resource value 2 are the first resource values, and the quantity of first resource values is 2.

Operation 3: Determine, based on an obtaining probability of the first resource value and the first basic value, an adjusted obtaining probability of the first resource value; and determine, based on an obtaining probability of a second resource value and the second basic value, an adjusted obtaining probability of the second resource value.

The second resource value is a largest resource value in the resource values. The first resource value is a resource value other than the second resource value in the resource values.

For example, the obtaining probability of the first resource value is reduced by the first basic value, to obtain the adjusted obtaining probability of the first resource value; and the obtaining probability of the second resource value is increased by the second basic value, to obtain the adjusted obtaining probability of the second resource value.

For example, the first resource values include the resource value 1, the resource value 2, the resource value 3, and the resource value 4, the second resource value includes the resource value 5, the first basic value is 1, and the second basic value is 4. The obtaining probability of the resource value 1 is 40%, and an adjusted obtaining probability of the resource value 1 obtained by using the foregoing method is 39%. The obtaining probability of the resource value 2 is 32%, and an adjusted obtaining probability of the resource value 2 obtained by using the foregoing method is 31%. The obtaining probability of the resource value 3 is 12%, and an adjusted obtaining probability of the resource value 3 obtained by using the foregoing method is 11%. The obtaining probability of the resource value 4 is 10%, and an adjusted obtaining probability of the resource value 4 obtained by using the foregoing method is 9%. The obtaining probability of the resource value 5 is 6%, and an adjusted obtaining probability of the resource value 5 obtained by using the foregoing method is 10%.

A sum of the adjusted obtaining probability of the first resource value and the adjusted obtaining probability of the second resource value is a sum of the obtaining probabilities of the resource values.

Because the battle result of the game object in the (i−1)^{th} turn reduces an obtaining probability of a low resource value and increases an obtaining probability of a high resource value, that is, reduces an obtaining probability of a piece of the low resource value and increases an obtaining probability of a piece of the high resource value, the game object may manage the battle result of the game object in the (i−1)^{th} turn to increase the obtaining probability of the high resource value, so that the game object has a greater probability of obtaining the piece of the high resource value. Therefore, a matching degree between a subsequently obtained piece and a game requirement of the game object is high, so that a probability that the game object obtains a desired piece can be improved, and fun of obtaining the piece can be improved, thereby improving the game experience of the game object, and improving the human computer interaction rate.

In an implementation, the battle information of the game object in the (i−1)^{th} turn further includes a target quantity of times, and the target quantity of times is a quantity of times for which the game object continuously obtains the battle result of the game object in the (i−1)^{th} turn. In other words, the battle information of the game object in the (i−1)^{th} turn further includes either of a quantity of continuous victories of the game object and a quantity of continuous failures of the game object. If the battle result of the game object in the (i−1)^{th} turn is a victory, the battle information of the game object in the (i−1)^{th} turn further includes a quantity of continuous victories of the game object. If the battle result of the game object in the (i−1)^{th} turn is a failure, the battle information of the game object in the (i−1)^{th} turn further includes a quantity of continuous failures of the game object.

The target quantity of times is the quantity of continuous victories of the game object based on that the battle result of the game object in the (i−1)^{th} turn is a victory. The target quantity of times is the quantity of continuous failures of the game object based on that the battle result of the game object in the (i−1)^{th} turn is a failure.

When the battle information of the game object in the (i−1)^{th} turn not only includes the battle result of the game object in the (i−1)^{th} turn but also includes the target quantity of times, the obtaining probabilities of the resource values are adjusted based on the battle result of the game object in the (i−1)^{th} turn and the target quantity of times, to obtain the adjusted obtaining probabilities of the resource values. The process includes: determining a difference between the target quantity of times and a reference quantity of times when the target quantity of times is greater than the reference quantity of times; determining a first additional value based on the difference between the quantities of times and a single additional value, the single additional value matching the battle result of the game object in the (i−1)^{th} turn; and determining a second additional value based on the quantity of the first resource values and the first additional value. The obtaining probability of the first resource value is reduced by the first basic value, to obtain an intermediate obtaining probability of the first resource value; and the intermediate obtaining probability of the first resource value is reduced by the first additional value, to obtain the adjusted obtaining probability of the first resource value. The obtaining probability of the second resource value is increased by the second basic value, to obtain an intermediate obtaining probability of the second resource value; and the intermediate obtaining probability of the second resource value is increased by the second additional value, to obtain the adjusted obtaining probability of the second resource value.

For example, the reference quantity of times is set based on experience or adjusted based on an implementation environment. This is not limited in this embodiment of this application. For example, the reference quantity of times is 3. In some embodiments, a single additional value when the battle result of the game object in the (i−1)^{th} turn is a failure may be greater than a single additional value when the battle result of the game object in the (i−1)^{th} turn is a victory. Setting is performed in this way because continuous failures have a higher risk, and the game object needs to obtain a piece of the high resource value. The piece of the high resource value has a stronger attribute and effect. Therefore, the game object can win from behind by using the piece of the high resource value, so that the game experience is more interesting.

The single additional value when the battle result of the game object in the (i−1)^{th} turn is a victory may be the same as or different from the single additional value when the battle result of the game object in the (i−1)^{th} turn is a failure. This is not limited in this embodiment of this application. For example, the single additional value when the battle result of the game object in the (i−1)^{th} turn is a victory is 1, and the single additional value when the battle result of the game object in the (i−1)^{th} turn is a failure is 2.

In some embodiments, a process of determining the first additional value based on the difference between the quantities of times and the single additional value includes: determining a product of the difference between the quantities of times and the single additional value, to obtain the first additional value. For example, the difference between the quantities of times is 2, and the single additional value is 1. In this case, the first additional value is 2*1=2.

In some embodiments, a process of determining the second additional value based on the quantity of the first resource values and the first additional value includes: determining a product of the quantity of the first resource values and the first additional value, to obtain the second additional value. For example, the quantity of the first resource values is 1, and the first additional value is 2. In this case, the second additional value is 1*2=2.

An example in which the game level of the game object is level 8 is used below. The resource values unlockable at the game level of the game object are the resource value 1, the resource value 2, the resource value 3, the resource value 4, and the resource value 5 (where the resource value 1, the resource value 2, the resource value 3, and the resource value 4 are the first resource values, and the resource value 5 is the second resource value). The obtaining probability of the resource value 1 is 40%, the obtaining probability of the resource value 2 is 32%, the obtaining probability of the resource value 3 is 12%, the obtaining probability of the resource value 4 is 10%, and the obtaining probability of the resource value 5 is 6%. The i^{th} turn is the 6^{th} turn. Battle information of the game object in the 5^{th} turn includes that a battle result of the game object in the 5^{th} turn is a victory. The game object achieves five continuous victories till the 5^{th} turn. The first basic value is 1, the second basic value is 4, the first additional value is 2, and the second additional value is 8. In this case, the obtaining probabilities of the resource values are adjusted according to the foregoing process, to obtain the adjusted obtaining probabilities of the resource values, which are respectively as follows: an adjusted obtaining probability of the resource value 1 is 37%, an adjusted obtaining probability of the resource value 2 is 29%, an adjusted obtaining probability of the resource value 3 is 9%, an adjusted obtaining probability of the resource value 4 is 7%, and an adjusted obtaining probability of the resource value 5 is 18%.

Because continuous victories or continuous failures of the game object reduces an obtaining probability of a low resource value and increases an obtaining probability of a high resource value, that is, reduces an obtaining probability of a piece of the low resource value and increases an obtaining probability of a piece of the high resource value, the game object may manage continuous victories or continuous failures to increase the obtaining probability of the high resource value, so that the game object has a greater probability of obtaining the piece of the high resource value. Therefore, a matching degree between a subsequently obtained piece and a game requirement of the game object is high, so that a probability that the game object obtains a desired piece can be improved, and fun of obtaining the piece can be improved, thereby improving the game experience of the game object, and improving the human computer interaction rate.

Operation 213: The server determines a target resource value from the resource values based on the adjusted obtaining probabilities of the resource values.

In an implementation, a process in which the server determines the target resource value from the resource values based on the adjusted obtaining probabilities of the resource values after determining the adjusted obtaining probabilities of the resource values in operation 212 is similar to the process of determining the reference resource value from the resource values based on the obtaining probabilities of the resource values in operation 204. Details are not described herein again in this embodiment of this application.

An adjusted obtaining probability of any resource value is a probability that the resource value is determined as the target resource value A process of determining the target resource value from the resource values based on the adjusted obtaining probabilities of the resource values is not limited in this embodiment of this application, provided that it is ensured that a probability that any one of the resource values is determined as the target resource value is an adjusted obtaining probability of the resource value. In some embodiments, an application program configured to determine the resource values is run in the server. The server inputs each resource value and an adjusted obtaining probability of each resource value into the application program, and obtains the target resource value based on an output result of the application program. In other words, the output result of the application program is used as the target resource value. In other words, the target resource value is a resource value randomly determined from the resource values based on the adjusted obtaining probabilities of the resource values unlockable at the game level of the game object.

For example, the target resource value determined by the server is the resource value 3.

Operation 214: The server transmits the target resource value to the terminal device.

After determining the target resource value in operation 213, the server transmits the target resource value to the terminal device, so that the terminal device displays the target resource value.

In some embodiments, after determining the adjusted obtaining probabilities of the resource values in operation 212, the server may further transmit the adjusted obtaining probabilities of the resource values to the terminal device, so that the terminal device displays the adjusted obtaining probabilities of the resource values, and further, the game object learns the adjusted obtaining probabilities of the resource values unlockable at the current game level of the game object.

Operation 215: The terminal device receives and displays the target resource value.

In an implementation, the terminal device receives the target resource value transmitted by the server, and displays the target resource value. The target resource value is configured for indicating a resource value of a piece available to the game object in the i^{th} turn. The target resource value is displayed, so that the game object can learn the resource value of the piece obtainable in the i^{th} turn.

In some embodiments, a process of displaying the target resource value includes: displaying a first page in the battle preparation page of the i^{th} turn, the target resource value being displayed in the first page. A position of the first page in the battle preparation page of the i^{th} turn may be set based on experience or adjusted based on an implementation environment. This is not limited in this embodiment of this application. For example, the position of the first page in the battle preparation page of the i^{th} turn may be a center position, a top position, or a bottom position in the battle preparation page of the i^{th} turn.

In an implementation, the terminal device may further receive the adjusted obtaining probabilities of the resource values transmitted by the server, and display the adjusted obtaining probabilities of the resource values. In this way, the game object can learn the probabilities of the resource values unlockable at the current game level of the game object. In some embodiments, the adjusted obtaining probabilities of the resource values are displayed in the first page. In some embodiments, the adjusted obtaining probabilities of the resource values are displayed in a page different from the first page in the battle preparation page of the i^{th} turn. In other words, the target resource value and the adjusted obtaining probabilities of the resource values may be displayed in two different pages in the battle preparation page of the i^{th} turn.

Because the target resource value is a resource value randomly determined from the resource values based on the adjusted obtaining probabilities of the resource values, even if the adjusted obtaining probabilities of the resource values are the same, finally determined target resource values may be different; and even if the adjusted obtaining probabilities of the resource values are different, finally determined target resource values may be the same.

FIG. 8 is a schematic diagram of display of a target resource value and adjusted obtaining probabilities of resource values according to an embodiment of this application. In FIG. 8, a first page 801 is displayed in the battle preparation page of the i^{th} turn, and a target resource value 802 is displayed in the first page 801. The adjusted obtaining probabilities of the resource values are displayed in 803 in the first page 801 in FIG. 8. An obtaining probability of the resource value 1 is 37%, an obtaining probability of the resource value 2 is 29%, an obtaining probability of the resource value 3 is 9%, an obtaining probability of the resource value 4 is 7%, and an obtaining probability of the resource value 5 is 18%.

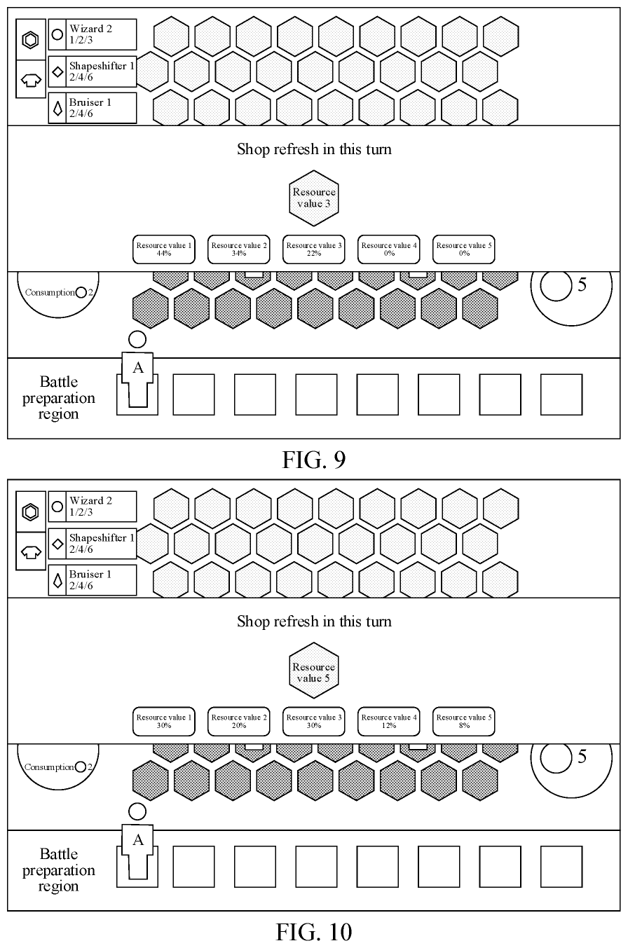

FIG. 9 is a schematic diagram of other display of a target resource value and adjusted obtaining probabilities of resource values according to an embodiment of this application. A target resource value displayed in FIG. 9 is the resource value 3. An obtaining probability of the resource value 1 is 44%, an obtaining probability of the resource value 2 is 34%, an obtaining probability of the resource value 3 is 22%, an obtaining probability of the resource value 4 is 0%, and an obtaining probability of the resource value 5 is 0%.

FIG. 10 is a schematic diagram of still other display of a target resource value and adjusted obtaining probabilities of resource values according to an embodiment of this application. A target resource value displayed in FIG. 10 is the resource value 5. An obtaining probability of the resource value 1 is 30%, an obtaining probability of the resource value 2 is 20%, an obtaining probability of the resource value 3 is 30%, an obtaining probability of the resource value 4 is 12%, and an obtaining probability of the resource value 5 is 8%.

Operation 216: The terminal device displays piece information of at least one standby piece when display duration of the target resource value is not less than a duration threshold.

Because the target resource value is displayed in the first page, the display duration of the target resource value is not less than the duration threshold refers to that display duration of the first page is not less than the duration threshold. The duration threshold is set based on experience or adjusted based on an implementation environment. This is not limited in this embodiment of this application. For example, the duration threshold is three seconds.

When the display duration of the first page is not less than the duration threshold, the terminal device cancels display of the first page, and displays the piece information of the at least one standby piece. For example, the piece information includes, but is not limited to, an image of a virtual object corresponding to the piece, a name of the piece, a type of the virtual object corresponding to the piece, and a resource value of the piece. A resource value of any standby piece is the target resource value.

In some embodiments, the standby piece may also be referred to as a selectable piece. In other words, the terminal device displays piece information of at least one selectable piece when the display duration of the target resource value is not less than the duration threshold.

A manner of displaying the piece information of the at least one standby piece is not limited in this embodiment of this application. In some embodiments, the terminal device displays a second page in the battle preparation page of the i^{th} turn, the piece information of the at least one standby piece being displayed in the second page. For example, because a display region of the second page is limited, a quantity of standby pieces displayed in the second page needs to be limited. For example, the quantity of the standby pieces displayed in the second page is not greater than a target quantity. The target quantity is set based on experience or adjusted based on an implementation environment. This is not limited in this embodiment of this application. For example, the target quantity is 5. In other words, when the piece information of the at least one standby piece is displayed in the second page, the quantity of the at least one standby piece is not greater than the target quantity.

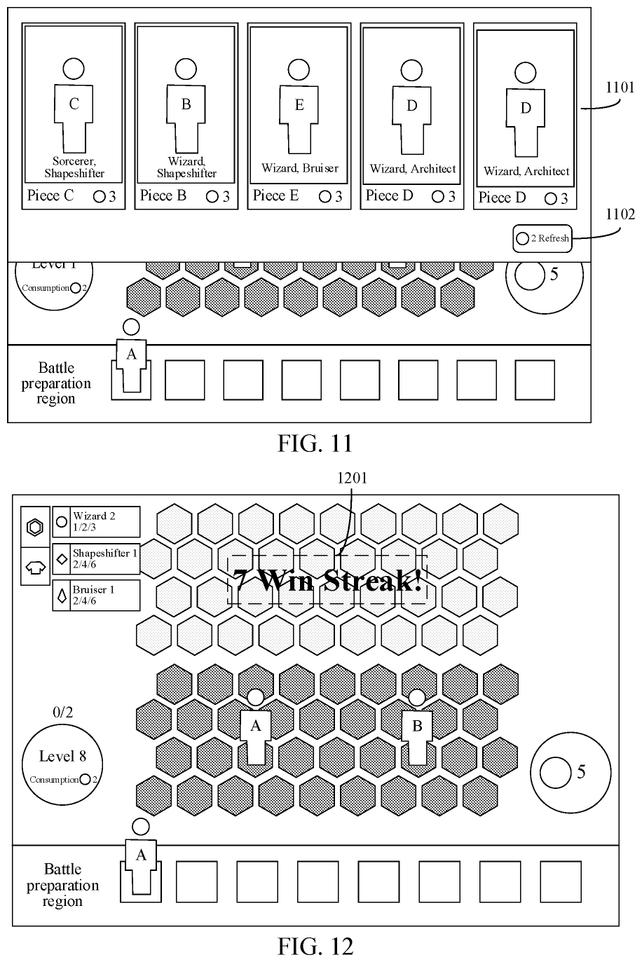

FIG. 11 is a schematic diagram of display of piece information of a standby piece according to an embodiment of this application. In FIG. 11, a second page 1101 is displayed in the battle preparation page of the i^{th} turn, and piece information of five standby pieces is displayed in the second page 1101. A name of the 1^{st} standby piece is a piece C, a type of a virtual object corresponding to the 1^{st} standby piece is Sorcerer and Shapeshifter, and a resource value of the 1^{st} standby piece is 3. Piece information of the other standby pieces is shown in FIG. 11, and details are not described herein.

In an implementation, before the piece information of the at least one standby piece is displayed, the piece information of the at least one standby piece needs to be obtained first. A manner of obtaining the piece information of the at least one standby piece is not limited in this embodiment of this application. In some embodiments, the following two manners of obtaining the piece information of the at least one standby piece are provided in this embodiment of this application.

First obtaining manner: Receive the piece information of the at least one standby piece that is transmitted by the server.

In the first obtaining manner, after determining the target resource value in operation 213, the server determines the at least one standby piece based on the target resource value, obtains the piece information of the standby piece, and further transmits the piece information of the standby piece to the terminal device, so that the terminal device obtains the piece information of the standby piece.

A process in which the server determines the at least one standby piece based on the target resource value is similar to a process in which the terminal device determines the at least one standby piece based on the target resource value in the following second obtaining manner. For details, refer to the following descriptions of the second obtaining manner, and details are not described herein.

In the manner in which the server determines the standby piece and transmits the piece information of the standby piece to the terminal device, because the terminal device does not need to determine the standby piece, resources of the terminal device can be saved, and a computational load of the terminal device can be reduced.

Second obtaining manner: The terminal device determines the at least one standby piece based on the target resource value, and obtains the piece information of the standby piece.

In the second obtaining manner, after receiving the target resource value transmitted by the server in operation 215, the terminal device determines the at least one standby piece based on the target resource value, and further obtains the piece information of the at least one standby piece.

For example, the process in which the terminal device determines the at least one standby piece based on the target resource value includes: The terminal device uses, as a second selectable piece, a piece whose resource value is the target resource value in candidate pieces, and determines the at least one standby piece from the second selectable piece. In some embodiments, second selectable pieces of a target quantity are determined from the second selectable piece as the at least one standby piece.

A manner in which the terminal device determines the standby piece and the piece information of the standby piece is beneficial to reducing a computational pressure of the server.

In some embodiments, after the terminal device displays the piece information of the at least one standby piece, the method further includes: displaying, in response to a refresh operation, piece information of a piece after the refresh, a resource value of the piece after the refresh being the target resource value. The refresh operation is configured for refreshing the at least one standby piece. After the piece information of the at least one standby piece is displayed, refreshing the displayed piece based on the refresh operation of the game object is further supported, to help improve a matching degree between the displayed piece and a game requirement of the game object, so that a probability that the game object obtains a desired piece is improved, and fun of obtaining the piece is improved, thereby improving game experience of the game object, and improving a human computer interaction rate.

A type of the refresh operation is not limited in this application. For example, the refresh operation may be a trigger operation for a refresh control, a voice configured for indicating refreshing, or a gesture configured for indicating refreshing.

For example, using an example in which the piece information of the at least one standby piece is displayed in the second page, a refresh control is further displayed in the second page, the refresh control being configured for refreshing the displayed at least one standby piece. In this case, displaying, in response to a refresh operation, piece information of a piece after the refresh may include: displaying the piece information of the piece after the refresh in the second page in response to a trigger operation for the refresh control, a resource value of the piece after the refresh being the target resource value.

In an exemplary embodiment, a quantity of pieces after the refresh is the same as a quantity of the at least one standby piece. The piece after the refresh may be completely the same as the at least one standby piece, or may not be completely the same as the at least one standby piece.

Before the piece information of the piece after the refresh is displayed in the second page, the piece information of the piece after the refresh needs to be obtained first. A process of obtaining the piece information of the piece after the refresh is similar to the process of obtaining the piece information of the standby piece. For details, refer to the process of obtaining the piece information of the standby piece. Details are not described herein again in this embodiment of this application.

For example, a value of resources required for refreshing may be displayed on the refresh control. In response to the trigger operation for the refresh control, the value of the resources required for refreshing is deducted from the account of the game object.

For example, a refresh control 1102 is displayed in the second page 1101 in FIG. 11. “2” displayed on the refresh control 1102 indicates that two resources are required for refreshing once. Therefore, in response to a trigger operation for the refresh control 1102, two resources are deducted from the account of the game object.

Operation 217: The terminal device obtains a first standby piece in the at least one standby piece in response to a trigger operation for piece information of the first standby piece.

After the piece information of the at least one standby piece is displayed, the game object may select and purchase the first standby piece from the standby piece, that is, obtain the first standby piece. The first standby piece is any one of the at least one standby piece.

In some embodiments, the standby piece may also be referred to as a selectable piece, and the first standby piece may also be referred to as a target piece. In other words, the terminal device obtains a target piece in at least one selectable piece in response to a trigger operation for piece information of the target piece.

In some embodiments, a process of obtaining the first standby piece in the at least one standby piece in response to the trigger operation for the piece information of the first standby piece includes: transmitting a piece issuing request to the server in response to the trigger operation for the piece information of the first standby piece in the at least one standby piece, the piece issuing request including the object identifier of the game object and the piece information of the first standby piece, and the piece issuing request being used by the server to deduct a resource of the target resource value from the account of the game object and issue the first standby piece to the account of the game object when a value of a resource included in the account of the game object is not less than the target resource value. The server receives and parses the piece issuing request, to obtain the object identifier of the game object and the piece information of the first standby piece, determines, based on the object identifier of the game object, the value of the resource included in the account of the game object, determines a resource value of the first standby piece based on the piece information of the first standby piece, and deducts the resource of the resource value of the first standby piece (the target resource value) from the account of the game object and issues the first standby piece to the account of the game object when the value of the resource included in the account of the game object is not less than the resource value of the first standby piece, so that the game object obtains the first standby piece.

The server transmits second prompt information to the terminal device when the server determines that the value of the resource included in the account of the game object is less than the resource value of the first standby piece. The second prompt information is configured for indicating that the game object cannot obtain the first standby piece. Content of the second prompt information may be any content configured for indicating that the game object cannot obtain the first standby piece. This is not limited in this embodiment of this application. After obtaining the second prompt information, the terminal device displays the second prompt information, so that the game object can learn an obtaining status of the game object for the first standby piece.

In an exemplary embodiment, in addition to the server as described in the foregoing content, the process of determining whether the value of the resource included in the account of the game object is less than the target resource value may alternatively be performed by the terminal device. In this case, the process of obtaining the first standby piece in the at least one standby piece in response to the trigger operation for the piece information of the first standby piece includes: The terminal device transmits a piece issuing request to the server in response to the trigger operation for the piece information of the first standby piece in the at least one standby piece when a value of a resource included in the account of the game object is not less than the target resource value, the piece issuing request including the object identifier of the game object and the piece information of the first standby piece, and the piece issuing request being used by the server to deduct a resource of the target resource value from the account of the game object and issue the first standby piece to the account of the game object.

The server receives and parses the piece issuing request, to obtain the object identifier of the game object and the piece information of the first standby piece, determines, based on the object identifier of the game object, the value of the resource included in the account of the game object, determines a resource value of the first standby piece based on the piece information of the first standby piece, and then deducts the resource of the resource value of the first standby piece (the target resource value) from the account of the game object and issues the first standby piece to the account of the game object, so that the game object obtains the first standby piece.

For example, the terminal device may further display prompt information when the value of the resource included in the account of the game object is less than the resource value of the first standby piece. The prompt information is configured for indicating that the game object cannot obtain the first standby piece.

The terminal device obtains the first standby piece, that is, the game object obtains the first standby piece, so that the game object can select, in the battle preparation page of the i^{th} turn, a piece that needs to be used in the battle stage of the i^{th} turn, and then enter the battle stage of the i^{th} turn. After the battle stage of the i^{th} turn ends, third prompt information is displayed in a battle page of the i^{th} turn. The third prompt information is configured for indicating battle information of the game object in the i^{th} turn. Then, the game object directly enters a battle preparation stage of an (i+1)^{th} turn. The third prompt information may be any content that can indicate the battle information of the game object in the i^{th} turn. This is not limited in this embodiment of this application.

FIG. 12 is a schematic diagram of display of third prompt information according to an embodiment of this application. In FIG. 12, third prompt information 1201 is displayed in the battle page of the i^{th} turn. Content of the third prompt information is “7 Win Streak!”. In other words, the battle information of the game object in the i^{th} turn is that a battle result of the game object in the i^{th} turn is a victory, and the game object achieves the 7^{th} victory in the i^{th} turn.

According to the foregoing method, when obtaining a piece in the i^{th} turn, the game object transmits the piece obtaining request to the server, so that the server determines the resource values unlockable at the game level of the game object based on the object identifier of the game object, and determines the target resource value from the resource values unlockable at the game level based on the battle information of the game object in the (i−1)^{th} turn, to further transmit the target resource value to the terminal device. In this way, the terminal device displays the piece information of the standby piece whose resource value is the target resource value, so that the game object selects and obtains a desired piece from the standby pieces. In this method, when the target resource value is determined, not only the game level of the game object is considered, but also the battle information of the game object in the previous turn is considered. Because the considered information is comprehensive, the determined target resource value better conforms to an actual battle situation of the game object. Because the resource value of the standby piece is the target resource value, a matching degree between the subsequently obtained piece and a game requirement of the game object is high, so that the game object obtains the desired piece can be improved, and fun of obtaining the piece can be improved, thereby improving game experience of the game object, and improving a human computer interaction rate.

In addition, because the target resource value returned by the server to the terminal device is determined from the unlockable resource values based on the battle information of the game object in the previous turn, the game object can manage the battle information in the previous turn to affect a process of determining the target resource value, so that game-theoretic fun can be brought to the game object, and a game control degree of the game object can be improved, thereby further improving a probability that the game object can obtain a desired piece in each turn, and further improving the human computer interaction rate.

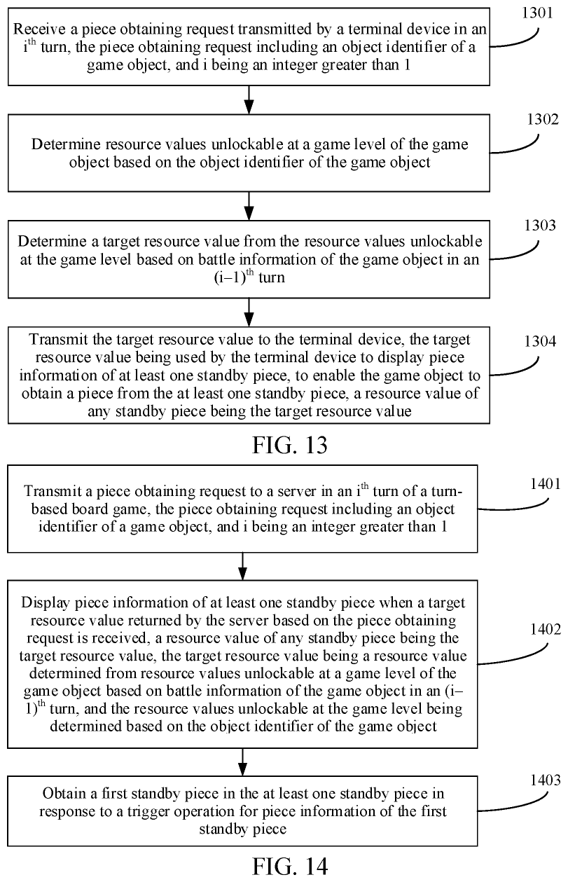

FIG. 13 is a flowchart of a method for obtaining a piece in a turn-based board game according to an embodiment of this application. The method may be performed by the server 102 in the computer system shown in FIG. 1. As shown in FIG. 13, the method includes the following operation 1301 to operation 1304.

Operation 1301: Receive a piece obtaining request transmitted by a terminal device in an i^{th} turn, the piece obtaining request including an object identifier of a game object, and i being an integer greater than 1.

In an implementation, a process of receiving the piece obtaining request transmitted by the terminal device in the i^{th} turn is already described in the foregoing operation 211. For details, refer to content of operation 211, and details are not described herein again.

Operation 1302: Determine resource values unlockable at a game level of the game object based on the object identifier of the game object.

In an implementation, a process of determining the resource values unlockable at the game level of the game object based on the object identifier of the game object is already described in the foregoing operation 211. For details, refer to content of operation 211, and details are not described herein again.

Operation 1303: Determine a target resource value from the resource values unlockable at the game level based on battle information of the game object in an (i−1)^{th} turn.

In an implementation, a process of determining the target resource value from the resource values unlockable at the game level based on the battle information of the game object in the (i−1)^{th} turn is already described in the foregoing operation 212 and operation 213. For details, refer to content of operation 212 and operation 213, and details are not described herein again.

Operation 1304: Transmit the target resource value to the terminal device, the target resource value being used by the terminal device to display piece information of at least one standby piece, to enable the game object to obtain a piece from the at least one standby piece, a resource value of any standby piece being the target resource value.

In an implementation, a process of transmitting the target resource value to the terminal device is already described in the foregoing operation 214. For details, refer to content of operation 214, and details are not described herein again.

According to the foregoing method, when obtaining a piece in the i^{th} turn, the game object transmits the piece obtaining request to the server, so that the server determines the resource values unlockable at the game level of the game object based on the object identifier of the game object, and determines the target resource value from the resource values unlockable at the game level based on the battle information of the game object in the (i−1)^{th} turn, to further transmit the target resource value to the terminal device. In this way, the terminal device displays the piece information of the standby piece whose resource value is the target resource value, so that the game object selects and obtains a desired piece from the standby pieces. In this method, when the target resource value is determined, not only the game level of the game object is considered, but also the battle information of the game object in the previous turn is considered. Because the considered information is comprehensive, the determined target resource value better conforms to an actual battle situation of the game object. Because the resource value of the standby piece is the target resource value, a matching degree between the subsequently obtained piece and a game requirement of the game object is high, so that the game object obtains the desired piece can be improved, and fun of obtaining the piece can be improved, thereby improving game experience of the game object, and improving a human computer interaction rate.

In addition, because the target resource value returned by the server to the terminal device is determined from the unlockable resource values based on the battle information of the game object in the previous turn, the game object can manage the battle information in the previous turn to affect a process of determining the target resource value, so that game-theoretic fun can be brought to the game object, and a game control degree of the game object can be improved, thereby further improving a probability that the game object can obtain a desired piece in each turn, and further improving the human computer interaction rate.

FIG. 14 is a flowchart of a method for obtaining a piece in a turn-based board game according to an embodiment of this application. The method may be performed by the terminal device 101 in the computer system shown in FIG. 1. As shown in FIG. 14, the method includes the following operation 1401 to operation 1403.

Operation 1401: Transmit a piece obtaining request to a server in an i^{th} turn of a turn-based board game, the piece obtaining request including an object identifier of a game object, and i being an integer greater than 1.

In an implementation, a process of transmitting the piece obtaining request to the server is already described in the foregoing operation 210. For details, refer to content of operation 210, and details are not described herein again.

Operation 1402: Display piece information of at least one standby piece when a target resource value returned by the server based on the piece obtaining request is received, a resource value of any standby piece being the target resource value, the target resource value being a resource value determined from resource values unlockable at a game level of the game object based on battle information of the game object in an (i−1)^{th} turn, and the resource values unlockable at the game level being determined based on the object identifier of the game object.

In an implementation, a process of displaying the piece information of the at least one standby piece when the target resource value returned by the server based on the piece obtaining request is received is already described in the foregoing operation 216. For details, refer to content of operation 216, and details are not described herein again.

Operation 1403: Obtain a first standby piece in the at least one standby piece in response to a trigger operation for piece information of the first standby piece.

In an implementation, a process of obtaining the first standby piece in the at least one standby piece in response to the trigger operation for the piece information of the first standby piece is already described in the foregoing operation 217. For details, refer to content of operation 217, and details are not described herein again.

According to the foregoing method, when obtaining a piece in the i^{th} turn, the game object transmits the piece obtaining request to the server, so that the server determines the resource values unlockable at the game level of the game object based on the object identifier of the game object, and determines the target resource value from the resource values unlockable at the game level based on the battle information of the game object in the (i−1)^{th} turn, to further transmit the target resource value to the terminal device. In this way, the terminal device displays the piece information of the standby piece whose resource value is the target resource value, so that the game object selects and obtains a desired piece from the standby pieces. In this method, when the target resource value is determined, not only the game level of the game object is considered, but also the battle information of the game object in the previous turn is considered. Because the considered information is comprehensive, the determined target resource value better conforms to an actual battle situation of the game object. Because the resource value of the standby piece is the target resource value, a matching degree between the subsequently obtained piece and a game requirement of the game object is high, so that the game object obtains the desired piece can be improved, and fun of obtaining the piece can be improved, thereby improving game experience of the game object, and improving a human computer interaction rate.

In addition, because the target resource value returned by the server to the terminal device is determined from the unlockable resource values based on the battle information of the game object in the previous turn, the game object can manage the battle information in the previous turn to affect a process of determining the target resource value, so that game-theoretic fun can be brought to the game object, and a game control degree of the game object can be improved, thereby further improving a probability that the game object can obtain a desired piece in each turn, and further improving the human computer interaction rate.

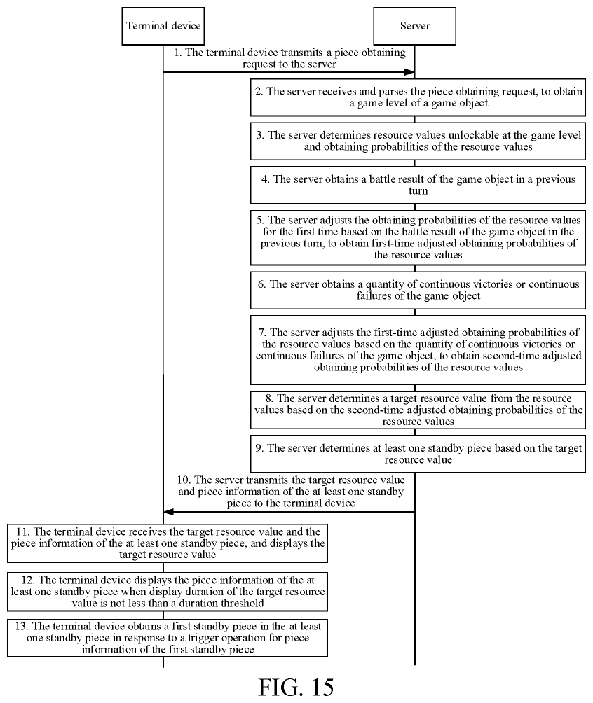

FIG. 15 is a flowchart of a method for obtaining a piece in a turn-based board game according to an embodiment of this application. As shown in FIG. 15, the method includes the following operations.
1. A terminal device transmits a piece obtaining request to a server.
2. The server receives and parses the piece obtaining request, to obtain a game level of a game object.
3. The server determines resource values unlockable at the game level and obtaining probabilities of the resource values.
4. The server obtains a battle result of the game object in a previous turn.
5. The server adjusts the obtaining probabilities of the resource values for the first time based on the battle result of the game object in the previous turn, to obtain first-time adjusted obtaining probabilities of the resource values.
6. The server obtains a quantity of continuous victories or continuous failures of the game object.
7. The server adjusts the first-time adjusted obtaining probabilities of the resource values based on the quantity of continuous victories or continuous failures of the game object, to obtain second-time adjusted obtaining probabilities of the resource values.
8. The server determines a target resource value from the resource values based on the second-time adjusted obtaining probabilities of the resource values.
9. The server determines at least one standby piece based on the target resource value.
10. The server transmits the target resource value and piece information of the at least one standby piece to the terminal device.
11. The terminal device receives the target resource value and the piece information of the at least one standby piece, and displays the target resource value.
12. The terminal device displays the piece information of the at least one standby piece when display duration of the target resource value is not less than a duration threshold.
13. The terminal device obtains a first standby piece in the at least one standby piece in response to a trigger operation for piece information of the first standby piece.

In the foregoing descriptions, only an example in which the method for obtaining a piece in a turn-based board game is performed through interaction between the terminal device and the server is used for description, and this embodiment of this application is not limited thereto. In some embodiments, the method for obtaining a piece in a turn-based board game may alternatively be independently performed by the terminal device.

For example, a process in which the terminal device independently performs the method for obtaining a piece in a turn-based board game includes: The terminal device determines, in an i^{th} turn of a turn-based board game, resource values unlockable at a game level of a game object; determines a target resource value from the resource values unlockable at the game level based on battle information of the game object in an (i−1)^{th} turn; displays piece information of at least one standby piece, a resource value of any standby piece being the target resource value; and obtains a first standby piece in the at least one standby piece in response to a trigger operation for piece information of the first standby piece.

An implementation principle that the terminal device independently performs the method for obtaining a piece in a turn-based board game is the same as the implementation principle of performing the method for obtaining a piece in a turn-based board game through interaction between the terminal device and the server described above, and details are not described herein again.

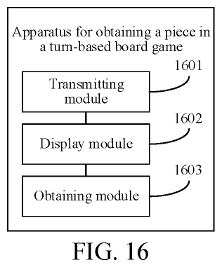

FIG. 16 is a schematic diagram of a structure of an apparatus for obtaining a piece in a turn-based board game according to an embodiment of this application. As shown in FIG. 16, the apparatus includes the following content:
a transmitting module 1601, configured to transmit a piece obtaining request to a server in an i^{th} turn of a turn-based board game, the piece obtaining request including an object identifier of a game object, and i being an integer greater than 1;
a display module 1602, configured to display piece information of at least one standby piece when a target resource value returned by the server based on the piece obtaining request is received, a resource value of any standby piece being the target resource value, the target resource value being a resource value determined from resource values unlockable at a game level of the game object based on battle information of the game object in an (i−1)^{th} turn, and the resource values unlockable at the game level being determined based on the object identifier of the game object; and
an obtaining module 1603, configured to obtain a first standby piece in the at least one standby piece in response to a trigger operation for piece information of the first standby piece.

In an implementation, the display module 1602 is configured to display the target resource value when the target resource value returned by the server is received, the target resource value being configured for indicating a resource value available to the game object in the i^{th} turn; and display the piece information of the at least one standby piece when display duration of the target resource value is not less than a duration threshold.

In an implementation, the display module 1602 is configured to display a first page in a battle preparation page of the i^{th} turn when the target resource value returned by the server is received, the target resource value being displayed in the first page; and display a second page in the battle preparation page of the i^{th} turn when display duration of the first page is not less than the duration threshold, the piece information of the at least one standby piece being displayed in the second page.

In an implementation, the apparatus further includes:
a receiving module, configured to receive adjusted obtaining probabilities that are returned by the server and that are of the resource values unlockable at the game level.

The display module 1602 is further configured to display the adjusted obtaining probabilities of the resource values.

In an implementation, the display module 1602 is further configured to display, in response to a refresh operation, piece information of a piece after the refresh, a resource value of the piece after the refresh being the target resource value, and the refresh operation being configured for refreshing the at least one standby piece.

In an implementation, the apparatus further includes:
the receiving module, configured to receive the piece information that is returned by the server and that is of the at least one standby piece.

Alternatively, the apparatus further includes:
a determining module, configured to determine the at least one standby piece from candidate pieces based on resource values of the candidate pieces and the target resource value, to obtain the piece information of the at least one standby piece.

In an implementation, the obtaining module 1603 is configured to transmit a piece issuing request to the server in response to the trigger operation for the piece information of the first standby piece in the at least one standby piece when a value of a resource included in an account of the game object is not less than the target resource value, the piece issuing request including the object identifier of the game object and the piece information of the first standby piece, and the piece issuing request being used by the server to deduct a resource of the target resource value from the account of the game object and issue the first standby piece to the account of the game object.

In the foregoing apparatus, when obtaining a piece in the i^{th} turn, the game object transmits the piece obtaining request to the server, so that the server determines the resource values unlockable at the game level of the game object based on the object identifier of the game object, and determines the target resource value from the resource values unlockable at the game level based on the battle information of the game object in the (i−1)^{th} turn, to further transmit the target resource value to the terminal device. In this way, the terminal device displays the piece information of the standby piece whose resource value is the target resource value, so that the game object selects and obtains a desired piece from the standby pieces. When the target resource value is determined, not only the game level of the game object is considered, but also the battle information of the game object in the previous turn is considered. Because the considered information is comprehensive, the determined target resource value better conforms to an actual battle situation of the game object. Because the resource value of the standby piece is the target resource value, a matching degree between the subsequently obtained standby piece and a game requirement of the game object is high, so that a probability that the game object obtains the desired piece can be improved, and fun of obtaining the piece can be improved, thereby improving game experience of the game object, and improving a human computer interaction rate.

In addition, because the target resource value returned by the server to the terminal device is determined from the unlockable resource values based on the battle information of the game object in the previous turn, the game object can manage the battle information in the previous turn to affect a process of determining the target resource value, so that game-theoretic fun can be brought to the game object, and a game control degree of the game object can be improved, thereby further improving a probability that the game object can obtain a desired piece in each turn, and further improving the human computer interaction rate.

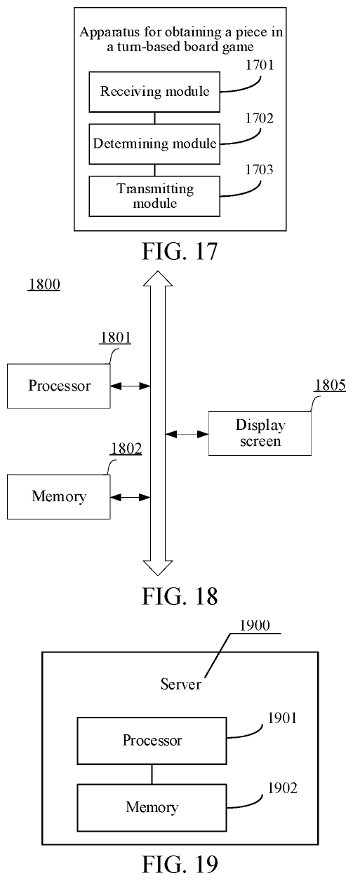

FIG. 17 is a schematic diagram of a structure of an apparatus for obtaining a piece in a turn-based board game according to an embodiment of this application. As shown in FIG. 17, the apparatus includes the following content:
a receiving module 1701, configured to receive a piece obtaining request transmitted by a terminal device in an i^{th} turn, the piece obtaining request including an object identifier of a game object, and i being an integer greater than 1;
a determining module 1702, configured to determine resource values unlockable at a game level of the game object based on the object identifier of the game object;
the determining module 1702 being further configured to determine a target resource value from the resource values unlockable at the game level based on battle information of the game object in an (i−1)^{th} turn; and
a transmitting module 1703, configured to transmit the target resource value to the terminal device, the target resource value being used by the terminal device to display piece information of at least one standby piece, to enable the game object to obtain a piece from the at least one standby piece, a resource value of any standby piece being the target resource value.

In an implementation, the determining module 1702 is configured to determine obtaining probabilities of the resource values unlockable at the game level; adjust the obtaining probabilities of the resource values based on the battle information of the game object in the (i−1)^{th} turn, to obtain adjusted obtaining probabilities of the resource values; and determine the target resource value from the resource values based on the adjusted obtaining probabilities of the resource values.

In an implementation, the battle information of the game object in the (i−1)^{th} turn includes a battle result of the game object in the (i−1)^{th} turn.

The determining module 1702 is configured to determine a first basic value matching the battle result of the game object in the (i−1)^{th} turn; determine a second basic value based on a quantity of first resource values and the first basic value; determine, based on an obtaining probability of the first resource value and the first basic value, an adjusted obtaining probability of the first resource value; and determine, based on an obtaining probability of a second resource value and the second basic value, an adjusted obtaining probability of the second resource value; the second resource value being a largest resource value in the resource values, and the first resource value being a resource value other than the second resource value in the resource values.

In an implementation, the determining module 1702 is configured to reduce the obtaining probability of the first resource value by the first basic value, to obtain the adjusted obtaining probability of the first resource value; and increase the obtaining probability of the second resource value by the second basic value, to obtain the adjusted obtaining probability of the second resource value.

In an implementation, the battle information of the game object in the (i−1)^{th} turn further includes a target quantity of times, and the target quantity of times is a quantity of times for which the game object continuously obtains the battle result of the game object in the (i−1)^{th} turn.

The determining module 1702 is further configured to determine a difference between the target quantity of times and a reference quantity of times when the target quantity of times is greater than the reference quantity of times; determine a first additional value based on the difference between the quantities of times and a single additional value; and determine a second additional value based on the quantity of the first resource values and the first additional value.

The determining module 1702 is configured to reduce the obtaining probability of the first resource value by the first basic value, to obtain an intermediate obtaining probability of the first resource value; and reduce the intermediate obtaining probability of the first resource value by the first additional value, to obtain the adjusted obtaining probability of the first resource value; and increase the obtaining probability of the second resource value by the second basic value, to obtain an intermediate obtaining probability of the second resource value; and increase the intermediate obtaining probability of the second resource value by the second additional value, to obtain the adjusted obtaining probability of the second resource value.

In an implementation, the determining module 1702 is further configured to determine the at least one standby piece from candidate pieces based on resource values of the candidate pieces and the target resource value.

The transmitting module 1703 is further configured to transmit the piece information of the at least one standby piece to the terminal device.

In an implementation, the transmitting module 1703 is further configured to transmit the adjusted obtaining probabilities of the resource values to the terminal device.

In an implementation, the receiving module 1701 is further configured to receive a piece issuing request, the piece issuing request including the object identifier of the game object and piece information of a first standby piece; and deduct a resource of the target resource value from an account of the game object, and issue the first standby piece to the account of the game object.

In the foregoing apparatus, when obtaining a piece in the i^{th} turn, the game object transmits the piece obtaining request to the server, so that the server determines the resource values unlockable at the game level of the game object based on the object identifier of the game object, and determines the target resource value from the resource values unlockable at the game level based on the battle information of the game object in the (i−1)^{th} turn, to further transmit the target resource value to the terminal device. In this way, the terminal device displays the piece information of the standby piece whose resource value is the target resource value, so that the game object selects and obtains a desired piece from the standby pieces. When the target resource value is determined, not only the game level of the game object is considered, but also the battle information of the game object in the previous turn is considered. Because the considered information is comprehensive, the determined target resource value better conforms to an actual battle situation of the game object. Because the resource value of the standby piece is the target resource value, a matching degree between the subsequently obtained standby piece and a game requirement of the game object is high, so that a probability that the game object obtains the desired piece can be improved, and fun of obtaining the piece can be improved, thereby improving game experience of the game object, and improving a human computer interaction rate.

In addition, because the target resource value returned by the server to the terminal device is determined from the unlockable resource values based on the battle information of the game object in the previous turn, the game object can manage the battle information in the previous turn to affect a process of determining the target resource value, so that game-theoretic fun can be brought to the game object, and a game control degree of the game object can be improved, thereby further improving a probability that the game object can obtain a desired piece in each turn, and further improving the human computer interaction rate.

When the apparatuses provided above implement functions of the apparatuses, only division into the foregoing function modules is used as an example for description. In the practical application, the functions may be allocated to and completed by different function modules based on requirements. In other words, an internal structure of a device is divided into different function modules, to complete all or a part of the functions described above. In addition, the apparatuses provided in the foregoing embodiments and the method embodiments belong to a same concept. For specific implementation processes thereof, refer to the method embodiments. Details are not described herein again.

An embodiment of this application provides a system for obtaining a piece in a turn-based board game, the system including a terminal device and a server.

The terminal device is configured to transmit a piece obtaining request to the server in an i^{th} turn of a turn-based board game, the piece obtaining request including an object identifier of a game object, and i being an integer greater than 1.

The server is configured to receive the piece obtaining request, and determine resource values unlockable at a game level of the game object based on the object identifier of the game object; determine a target resource value from the resource values unlockable at the game level based on battle information of the game object in an (i−1)^{th} turn; and transmit the target resource value to the terminal device.

The terminal device is further configured to display piece information of at least one standby piece when receiving the target resource value, a resource value of any standby piece being the target resource value; and obtain a first standby piece in the at least one standby piece in response to a trigger operation for piece information of the first standby piece.

In an implementation, the server is configured to determine obtaining probabilities of the resource values unlockable at the game level; adjust the obtaining probabilities of the resource values based on the battle information of the game object in the (i−1)^{th} turn, to obtain adjusted obtaining probabilities of the resource values; and determine the target resource value from the resource values based on the adjusted obtaining probabilities of the resource values.

In an implementation, the battle information of the game object in the (i−1)^{th} turn includes a battle result of the game object in the (i−1)^{th} turn. The server is configured to determine a first basic value matching the battle result of the game object in the (i−1)^{th} turn; determine a second basic value based on a quantity of first resource values and the first basic value; determine, based on an obtaining probability of the first resource value and the first basic value, an adjusted obtaining probability of the first resource value; and determine, based on an obtaining probability of a second resource value and the second basic value, an adjusted obtaining probability of the second resource value; the second resource value being a largest resource value in the resource values, and the first resource value being a resource value other than the second resource value in the resource values.

In an implementation, the server is configured to reduce the obtaining probability of the first resource value by the first basic value, to obtain the adjusted obtaining probability of the first resource value; and increase the obtaining probability of the second resource value by the second basic value, to obtain the adjusted obtaining probability of the second resource value.

In an implementation, the battle information of the game object in the (i−1)^{th} turn further includes a target quantity of times, and the target quantity of times is a quantity of times for which the game object continuously obtains the battle result of the game object in the (i−1)^{th} turn. The server is configured to determine a difference between the target quantity of times and a reference quantity of times when the target quantity of times is greater than the reference quantity of times; determine a first additional value based on the difference between the quantities of times and a single additional value; determine a second additional value based on the quantity of the first resource values and the first additional value; reduce the obtaining probability of the first resource value by the first basic value, to obtain an intermediate obtaining probability of the first resource value; reduce the intermediate obtaining probability of the first resource value by the first additional value, to obtain the adjusted obtaining probability of the first resource value; increase the obtaining probability of the second resource value by the second basic value, to obtain an intermediate obtaining probability of the second resource value; and increase the intermediate obtaining probability of the second resource value by the second additional value, to obtain the adjusted obtaining probability of the second resource value.

In an implementation, the server is further configured to determine the at least one standby piece from candidate pieces based on resource values of the candidate pieces and the target resource value; and transmit the piece information of the at least one standby piece to the terminal device.

The terminal device is further configured to receive the piece information that is returned by the server and that is of the at least one standby piece.

In an implementation, the server is further configured to transmit the adjusted obtaining probabilities of the resource values to the terminal device.

The terminal device is further configured to receive the adjusted obtaining probabilities of the resource values returned by the server, and display the adjusted obtaining probabilities of the resource values.

In an implementation, the terminal device is configured to display the target resource value when the target resource value returned by the server is received, the target resource value being configured for indicating a resource value available to the game object in the i^{th} turn; and display the piece information of the at least one standby piece when display duration of the target resource value is not less than a duration threshold.

In an implementation, the terminal device is configured to display a first page in a battle preparation page of the i^{th} turn when the target resource value returned by the server is received, the target resource value being displayed in the first page; and display a second page in the battle preparation page of the i^{th} turn when display duration of the first page is not less than the duration threshold, the piece information of the at least one standby piece being displayed in the second page.

In an implementation, the terminal device is further configured to display, in response to a refresh operation, piece information of a piece after the refresh, a resource value of the piece after the refresh being the target resource value, and the refresh operation being configured for refreshing the at least one standby piece.

In an implementation, the terminal device is further configured to determine the at least one standby piece from candidate pieces based on resource values of the candidate pieces and the target resource value, to obtain the piece information of the at least one standby piece.

In an implementation, the terminal device is configured to transmit a piece issuing request to the server in response to the trigger operation for the piece information of the first standby piece in the at least one standby piece when a value of a resource included in an account of the game object is not less than the target resource value, the piece issuing request including the object identifier of the game object and the piece information of the first standby piece.

The server is further configured to receive a piece issuing request; and deduct a resource of the target resource value from an account of the game object, and issue the first standby piece to the account of the game object.

The system provided in the foregoing embodiment and the method embodiments belong to a same concept. For specific implementation processes thereof, refer to the method embodiments. Details are not described herein again.

FIG. 18 is a block diagram of a structure of a terminal device 1800 according to an exemplary embodiment of this application. The terminal device 1800 may be any electronic device product that may perform human-computer interaction with a user in one or more manners such as a keyboard, a touch pad, a remote control, voice interaction, or a handwriting device, for example, a personal computer (PC), a mobile phone, a smartphone, a personal digital assistant (PDA), a wearable device, a pocket PC (PPC), a tablet computer, smart in-vehicle infotainment, a smart television, a smart speaker, or a smart watch.

The terminal device 1800 includes a processor 1801 and a memory 1802.

The processor 1801 may include one or more processing cores, for example, the processor 1801 may be a 4-core processor or an 8-core processor. The processor 1801 may be implemented in at least one hardware form of a digital signal processor (DSP), a field-programmable gate array (FPGA), and a programmable logic array (PLA). The processor 1801 may alternatively include a main processor and a co-processor. The main processor is a processor configured to process data in an awoken state, and is also referred to as a central processing unit (CPU). The co-processor is a low-power consumption processor configured to process data in a standby state. In some embodiments, the processor 1801 may be integrated with a graphics processing unit (GPU). The GPU is configured to render and draw content that needs to be displayed on a display screen. In some embodiments, the processor 1801 may further include an artificial intelligence (AI) processor. The AI processor is configured to process a computing operation related to machine learning.

The memory 1802 may include one or more computer-readable storage media. The computer-readable storage medium may be non-transient. In addition, the memory 1802 may further include a high-speed random access memory and a non-volatile memory, for example, one or more magnetic disk storage devices or flash memory devices. In some embodiments, the non-transient computer-readable storage medium in the memory 1802 is configured to store at least one instruction, and the at least one instruction is configured for being executed by the processor 1801 to implement the method for obtaining a piece in a turn-based board game provided in the method embodiment shown in FIG. 14 in this application. In some embodiments, non-transient may also be referred to as non-volatile.

In some embodiments, the terminal device 1800 may further include a display screen 1805.

The display screen 1805 is configured to display a user interface (UI). The UI may include a graph, a text, an icon, a video, and any combination thereof. When the display screen 1805 is a touch display screen, the display screen 1805 further has a capability of collecting a touch signal on or above a surface of the display screen 1805. The touch signal may be inputted to the processor 1801 as a control signal for processing. In this case, the display screen 1805 may be further configured to provide a virtual button and/or a virtual keyboard, also referred to as a soft button and/or a soft keyboard. In some embodiments, there may be one display screen 1805 disposed on a front panel of the terminal device 1800. In some other embodiments, there may be at least two display screens 1805 respectively disposed on different surfaces of the terminal device 1800 or designed in a foldable shape. In some other embodiments, the display screen 1805 may be a flexible display screen disposed on a curved surface or a folded surface of the terminal device 1800. In addition, the display screen 1805 may alternatively be set to a non-rectangular irregular pattern, namely, a special-shaped screen. The display screen 1805 may be prepared by using a material such as a liquid crystal display (LCD) or an organic light-emitting diode (OLED). In some embodiments, the piece information of the piece, the target resource value, and the like are displayed by using the display screen 1805.

A person skilled in the art may understand that the structure of shown in FIG. 18 constitutes no limitation on the terminal device 1800, and the terminal device 1800 may include more or fewer components than those shown in the figure, or some components may be combined, or in different component arrangements.

FIG. 19 is a schematic diagram of a structure of a server according to an embodiment of this application. The server 1900 may vary a lot due to different configurations or performance, and may include one or more processors (Central Processing Units, CPUs) 1901 and one or more memories 1902. The one or more memories 1902 store at least one piece of program code, and the at least one piece of program code is loaded and executed by the one or more processors 1901 to implement the method for obtaining a piece in a turn-based board game provided in the method embodiment shown in FIG. 13 in this application. Certainly, the server 1900 may further have a wired or wireless network interface, a keyboard, an input/output interface and other components to facilitate input/output. The server 1900 may further include other components for implementing device functions. Details are not described herein again.

In an exemplary embodiment, a non-transitory computer-readable storage medium is further provided, having at least one program code stored therein, the at least one program code being loaded and executed by a processor, to enable a computer to implement any one of the foregoing methods for obtaining a piece in a turn-based board game.

In some embodiments, the foregoing non-transitory computer-readable storage medium may be a read-only memory (ROM), a random access memory (RAM), a compact disc read-only memory (CD-ROM), a magnetic tape, a floppy disk, an optical data storage device, or the like.

In an exemplary embodiment, a computer program or computer program product is further provided, having at least one computer instruction stored therein, the at least one computer instruction being loaded and executed by a processor, to enable a computer to implement any one of the foregoing methods for obtaining a piece in a turn-based board game.

Information (including but not limited to user equipment information, user personal information, and the like), data (including but not limited to data for analysis, data for storage, data for display, and the like), and signals mentioned in this application are all authorized by users or fully authorized by all parties, and collection, use, and processing of relevant data need to comply with relevant laws, regulations, and standards of relevant countries and regions. For example, all information such as the piece information, the resource value, and the obtaining probability of the resource value involved in this application is obtained under full authorization.

“A plurality of” mentioned in this specification means two or more. “And/or” describes an association relationship between associated objects and represents that three relationships may exist. For example, A and/or B may represent the following three cases: Only A exists, both A and B exist, and only B exists. The character “/” usually indicates an “or” relationship between the associated objects.

The foregoing descriptions are merely exemplary embodiments of this application, and are not intended to limit this application. Any modification, equivalent replacement, or improvement made within the principle of this application shall fall within the protection scope of this application.

What is claimed is:

1. A method for obtaining a piece in a turn-based board game performed by a computer device, and the method comprising:
displaying a battle preparation interface for the turn-based board game, the battle interface including a battle preparation region and a board region;
in response to a user selection of the battle preparation region, transmitting a piece obtaining request to a server in an i^{th} turn of the turn-based board game, the piece obtaining request comprising an object identifier of the game object, and i being an integer greater than 1;
displaying piece information of at least one standby piece in the battle preparation interface, wherein any standby piece has a target resource value determined from resource values unlockable at a game level of the game object based on battle information of the game object in an (i−1)^{th} turn and the object identifier of the game object; and
in response to a trigger operation for piece information of a first standby piece on the battle preparation interface, adding the first standby piece to the battle preparation region.

2. The method according to claim 1, wherein the displaying piece information of at least one standby piece in the battle preparation interface comprises:
displaying the target resource value, the target resource value being configured for indicating a resource value available to the game object in the i^{th} turn; and
displaying the piece information of the at least one standby piece when display duration of the target resource value is not less than a duration threshold.

3. The method according to claim 2, wherein the displaying the target resource value comprises:
displaying a first page in the battle preparation interface of the i^{th} turn, the target resource value being displayed in the first page; and
the displaying the piece information of the at least one standby piece when display duration of the target resource value is not less than a duration threshold comprises:
displaying a second page in the battle preparation interface of the i^{th} turn when display duration of the first page is not less than the duration threshold, the piece information of the at least one standby piece being displayed in the second page.

4. The method according to claim 1, wherein the method further comprises:
receiving obtaining probabilities of the resource values unlockable at the game level adjusted by the server according to the battle information of the game object in the (i−1)^{th} turn; and
displaying the adjusted obtaining probabilities of the resource values in the battle preparation interface.

5. The method according to claim 1, wherein the battle preparation interface includes a refresh control and the method further comprises:
in response to a user operation on the refresh control within a duration threshold, replacing the piece information of at least one standby piece with piece information of a new piece after the refresh, a resource value of the piece new after the refresh being the target resource value.

6. The method according to claim 1, wherein the method further comprises:
receiving piece information of candidate pieces returned by the server; and
determining the at least one standby piece from the candidate pieces based on resource values of the candidate pieces and the target resource value, to obtain the piece information of the at least one standby piece.

7. The method according to claim 1, wherein the method further comprises:
in response to the trigger operation for the piece information of the first standby piece, transmitting a piece issuing request to the server, the piece issuing request comprising the object identifier of the game object and the piece information of the first standby piece, wherein the server is configured to deduct a resource of the target resource value from an account of the game object and issue the first standby piece to the account of the game object.

8. A computer device, comprising a processor and a memory, the memory having at least one program code stored therein, and the at least one program code, when loaded and executed by the processor, causing the computer device to implement a method for obtaining a piece in a turn-based board game including:
displaying a battle preparation interface for the turn-based board game, the battle interface including a battle preparation region and a board region;
in response to a user selection of the battle preparation region, transmitting a piece obtaining request to a server in an i^{th} turn of the turn-based board game, the piece obtaining request comprising an object identifier of the game object, and i being an integer greater than 1;
displaying piece information of at least one standby piece in the battle preparation interface, wherein any standby piece has a target resource value determined from resource values unlockable at a game level of the game object based on battle information of the game object in an (i−1)^{th} turn and the object identifier of the game object;
in response to a trigger operation for piece information of a first standby piece on the battle preparation interface, adding the first standby piece to the battle preparation region.

9. The computer device according to claim 8, wherein the displaying piece information of at least one standby piece in the battle preparation interface comprises:
displaying the target resource value, the target resource value being configured for indicating a resource value available to the game object in the i^{th} turn; and
displaying the piece information of the at least one standby piece when display duration of the target resource value is not less than a duration threshold.

10. The computer device according to claim 9, wherein the displaying the target resource value comprises:
displaying a first page in the battle preparation interface of the i^{th} turn, the target resource value being displayed in the first page; and
the displaying the piece information of the at least one standby piece when display duration of the target resource value is not less than a duration threshold comprises:
displaying a second page in the battle preparation interface of the i^{th} turn when display duration of the first page is not less than the duration threshold, the piece information of the at least one standby piece being displayed in the second page.

11. The computer device according to claim 8, wherein the method further comprises:
receiving obtaining probabilities of the resource values unlockable at the game level adjusted by the server according to the battle information of the game object in the (i−1)^{th} turn; and
displaying the adjusted obtaining probabilities of the resource values in the battle preparation interface.

12. The computer device according to claim 8, wherein the battle preparation interface includes a refresh control and the method further comprises:
in response to a user operation on the refresh control within a duration threshold, replacing the piece information of at least one standby piece with piece information of a new piece after the refresh, a resource value of the piece new after the refresh being the target resource value.

13. The computer device according to claim 8, wherein the method further comprises:
receiving piece information of candidate pieces returned by the server; and
determining the at least one standby piece from the candidate pieces based on resource values of the candidate pieces and the target resource value, to obtain the piece information of the at least one standby piece.

14. The computer device according to claim 8, wherein the method further comprises:
in response to the trigger operation for the piece information of the first standby piece, transmitting a piece issuing request to the server, the piece issuing request comprising the object identifier of the game object and the piece information of the first standby piece, wherein the server is configured to deduct a resource of the target resource value from an account of the game object and issue the first standby piece to the account of the game object.

15. A non-transitory computer-readable storage medium, having at least one program code stored therein, the at least one program code, when loaded and executed by a processor of a computer device, causing the computer device to implement a method for obtaining a piece in a turn-based board game including:
displaying a battle preparation interface for the turn-based board game, the battle interface including a battle preparation region and a board region;
in response to a user selection of the battle preparation region, transmitting a piece obtaining request to a server in an i^{th} turn of the turn-based board game, the piece obtaining request comprising an object identifier of the game object, and i being an integer greater than 1;
displaying piece information of at least one standby piece in the battle preparation interface, wherein any standby piece has a target resource value determined from resource values unlockable at a game level of the game object based on battle information of the game object in an (i−1)^{th} turn and the object identifier of the game object;
in response to a trigger operation for piece information of a first standby piece on the battle preparation interface, adding the first standby piece to the battle preparation region.

16. The non-transitory computer-readable storage medium according to claim 15, wherein the displaying piece information of at least one standby piece in the battle preparation interface comprises:
displaying the target resource value, the target resource value being configured for indicating a resource value available to the game object in the i^{th} turn; and
displaying the piece information of the at least one standby piece when display duration of the target resource value is not less than a duration threshold.

17. The non-transitory computer-readable storage medium according to claim 15, wherein the method further comprises:
receiving obtaining probabilities of the resource values unlockable at the game level adjusted by the server according to the battle information of the game object in the (i−1)^{th} turn; and
displaying the adjusted obtaining probabilities of the resource values in the battle preparation interface.

18. The non-transitory computer-readable storage medium according to claim 15, wherein the battle preparation interface includes a refresh control and the method further comprises:
in response to a user operation on the refresh control within a duration threshold, replacing the piece information of at least one standby piece with piece information of a new piece after the refresh, a resource value of the piece new after the refresh being the target resource value.

19. The non-transitory computer-readable storage medium according to claim 15, wherein the method further comprises:
receiving piece information of candidate pieces returned by the server; and
determining the at least one standby piece from the candidate pieces based on resource values of the candidate pieces and the target resource value, to obtain the piece information of the at least one standby piece.

20. The non-transitory computer-readable storage medium according to claim 15, wherein the method further comprises:
in response to the trigger operation for the piece information of the first standby piece, transmitting a piece issuing request to the server, the piece issuing request comprising the object identifier of the game object and the piece information of the first standby piece, wherein the server is configured to deduct a resource of the target resource value from an account of the game object and issue the first standby piece to the account of the game object.
